(19) United States
(12) Patent Application Publication
(10) Pub. No.: US 2026/0304512 A1
(43) Pub. Date: Oct. 1, 2026

(54) METHODS AND APPARATUSES FOR ENABLING LOW-LATENCY DATA COLLECTION AND DELIVERY

(71) Applicant: InterDigital Patent Holdings, Inc., Willmington, DE (US)

(72) Inventors: Xavier De Foy, Kirkland, CA (US); Ulises Olvera-Hernandez, Saint-Lazare (CA); Rocco Di Girolamo, Laval (CA); Michael Starsinic, Newtown, PA (US); James Miller, Northport, NY (US); Hyunsik Yang, Leonia, NJ (US); Michel Roy, Candiac (CA); Samir Ferdi, Kirkland (CA)

(73) Assignee: InterDigital Patent Holdings, Inc., Willmington, DE (US)

(21) Appl. No.: 19/092,721

(22) Filed: Mar. 27, 2025

(51) Int. Cl. H04W 76/14; H04W 4/38; H04W 8/20

(52) U.S. Cl. CPC H04W 76/14; H04W 4/38; H04W 8/20

(57) ABSTRACT

Methods, systems, and apparatuses are provided for enabling low-latency data collection and delivery in wireless communication networks. A network may configure a wireless transmit/receive unit (WTRU) to connect to a data collection and delivery network (DCDN). Upon occurrence of an event and/or receiving a trigger, the WTRU may trigger a procedure to connect to the DCDN. The WTRU may connect to a peer, based on a DCDN configuration received from the network. The WTRU may act as a publisher node in the DCDN that announces one or more namespaces, receives one or more subscriptions, triggers one or more measurements and/or sends more or more measurements. The WTRU may act as a subscriber node that subscribes to one or more data streams and receives the one or more data streams. The WTRU may act as a forwarder node that forwards one or more announcements, subscriptions and/or data streams.

### BACKGROUND

Various types of applications running on various types of devices may be inter-connected with each other, in distributed, centralized, and/or hybrid manner. Different types of data collection mechanisms may be used for these applications. These data collection mechanisms are needed for data emitted by multiple data sources, some of which are connected to the network through user equipment, and some of which are user equipment. These devices may be interconnected through different types of wired and/or wireless interfaces. Efficient data delivery mechanisms are required for proper functioning of the applications and the devices.

### SUMMARY

In one or more embodiments, a method performed by a wireless transmit/receive unit (WTRU) is provided. The method comprises receiving configuration information including one or more data collection and delivery network (DCDN) configuration information elements (IEs) indicative of DCDN connectivity information and DCDN peer information. The method includes establishing, based on the one or more DCDN configuration IEs, a DCDN connection with a DCDN peer. The method includes transmitting, based on the one or more DCDN configuration IEs, an announcement message including a namespace. The method includes receiving, from the DCDN peer, a subscription message including a data stream identifier (ID). The method includes collecting, based on the subscription message, one or more data objects corresponding to the data stream ID. The method includes transmitting, to the DCDN peer, a message determined based on the one or more data objects, over the DCDN connection.

In an embodiment, the one or more DCDN configuration IEs are received using one or more of: a control plane (CP) message, a user plane (UP) message, or a DCDN policy rule.

In an embodiment, the method comprises receiving a trigger for establishing a connection with the DCDN peer. The DCDN connection is established based at least on the trigger.

In an embodiment, the one or more DCDN configuration IEs include a DCDN trigger IE indicative of the trigger.

In an embodiment, the method comprises determining that the subscription message is acceptable. The method comprises transmitting, to the DCDN peer, a subscription response including the data stream ID indicating that the subscription message is accepted.

In an embodiment, determining that the subscription message is acceptable comprises one or more of: determining that the data stream ID indicated by the subscription message is valid, determining that subscription message is consented by a user, or determining that one or more service thresholds associated with the subscription message are met.

In an embodiment, establishing the DCDN connection comprises one of: establishing a protocol data unit (PDU) session used for the DCDN connection, or using an existing PDU session for the DCDN connection.

In an embodiment, the namespace includes a set of data streams IDs associated with the WTRU.

In an embodiment, collecting the one or more data objects comprises initiating generation of the one or more data objects by a data source.

In an embodiment, the method further comprises encoding the one or more data objects. The message comprises at least one of: the one or more data objects or one or more encoded data objects.

In one or more embodiments, a WTRU is provided. The WTRU comprises a transceiver and a processor. The transceiver and the processor are configured to receive configuration information including one or more DCDN configuration IEs indicative of DCDN connectivity information and DCDN peer information. The transceiver and the processor are configured to establish, based on the one or more DCDN configuration IEs, a DCDN connection with a DCDN peer. The transceiver and the processor are configured to transmit, based on the one or more DCDN configuration IEs, an announcement message including a namespace. The transceiver and the processor are configured to receive, from the DCDN peer, a subscription message including a data stream ID. The transceiver and the processor are configured to collect, based on the subscription message, one or more data objects corresponding to the data stream ID. The transceiver and the processor are configured to transmit, to the DCDN peer, a message determined based on the one or more data objects over the DCDN connection.

In an embodiment, the one or more DCDN configuration IEs are received using one or more of: a CP message, a UP message, or a DCDN policy rule.

In an embodiment, the transceiver and the processor are further configured to receive a trigger for establishing a connection with the DCDN peer. The DCDN connection is established based at least on the trigger.

In an embodiment, the one or more DCDN configuration IEs include a DCDN trigger IE indicative of the trigger.

In an embodiment, the transceiver and the processor are further configured to determine that the subscription message is acceptable. The transceiver and the processor are further configured to transmit, to the DCDN peer, a subscription response including the data stream ID indicating that the subscription message is accepted.

In an embodiment, determining that the subscription message is acceptable comprises one or more of: determining that the data stream ID indicated by the subscription message is valid, determining that subscription message is consented by a user, or determining that one or more service thresholds associated with the subscription message are met.

In an embodiment, establishing the DCDN connection comprises one of: establishing a protocol data unit (PDU) session used for the DCDN connection, or using an existing PDU session for the DCDN connection.

In an embodiment, the namespace includes a set of data streams IDs associated with the WTRU.

In one or more embodiments, a method performed by a radio access network (RAN) node is provided. The method includes receiving, from a core network (CN) node, configuration information including one or more DCDN configuration IEs. The method includes establishing, based on the one or more DCDN configuration IEs, an internet protocol (IP) connection with a DCDN peer over an IP network. The method includes receiving a subscription message from the DCDN peer including a data stream ID. The method includes transmitting, based on the subscription message, one or more data objects to corresponding to the data stream ID to the DCDN peer.

In an embodiment, the method includes transmitting a message to a WTRU for initiating data collection. The method includes receiving, from the WTRU, at least one message comprising the one or more data objects corresponding to the data stream ID.

In an embodiment, the method includes generating the one or more data objects.

In an embodiment, the method includes transmitting an announcement message including a namespace including a set of data streams IDs associated with the RAN node.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIGS. 2A-2B illustrate an example data collection and delivery network (DCDN) architecture according to one or more embodiments;

FIG. 3 illustrates a flow diagram for an example method of a DCDN operation according to one or more embodiments;

FIGS. 4A-4B illustrate a flow diagram of an example procedure where a WTRU publishes and sends one or more measurements through a DCDN network according to one or more embodiments;

FIGS. 5A-5B illustrate a flow diagram of an example method where a WTRU acts as a DCDN forwarder between a WTRU and a DCDN network according to one or more embodiments;

FIG. 6 illustrates a flow diagram of an example procedure where a WTRU subscribes and receives one or more model updates from a DCDN network according to one or more embodiments; and

FIG. 7 illustrates a flowchart of an example method of enabling low-latency data collection and delivery according to one or more embodiments.

### DETAILED DESCRIPTION

The following non-exhaustive list of abbreviations in Table 1 may be used in this disclosure:

TABLE 1

| | |
|---|---|
| 5GS | 5G System |
| AF | Application Function |
| AI | Artificial Intelligence |
| ML | Machine Learning |
| API | Application Programing Interface |
| AS | Application Server |
| CDN | Content Delivery Network |
| CP | Control Plane |
| D2D | Device to Device |
| DCDN | Data Collection and Delivery Network |
| DHCP | Dynamic Host Configuration Protocol |
| DN | Data Network |
| DNN | Data Network Name |
| DNS | Domain Name System |
| DSCP | Differentiated Services Code Point |
| FQDN | Fully Qualified Domain Name |
| HTTP | Hypertext Transfer Protocol |
| ID | Identifier |
| IE | Information Element |
| IP | Internet Protocol (IPv4: IP version 4, IPv6: IP version 6) |
| MOQ | Media over QUIC |
| MQTT | Message Queue Telemetry Transport |
| N6 | Interface defined by 3GPP between UPF and DN |
| NAS | Non-Access Stratum |
| NEF | Network Exposure Function |
| NF | Network Function |
| OAM | Operation, Administration and Management |
| PCF | Policy Control Function |
| PDU | Protocol Data Unit |
| PSA UPF | PDU Session Anchor UPF |
| PvD | Provisioning Domain |
| QoS | Quality of Service |
| RA | Router Advertisement |
| RAN | Radio Access Network |
| SDF | Service Data Flow |
| SMF | Session Management Function |
| S-NSSAI | Single Network Slice Selection Assistance Information |
| UDP | User Datagram Protocol |
| UE | User Equipment |
| UP | User Plane |
| UPF | User Plane Function |
| URL | Universal Resource Locator |
| URI | Universal Resource Identifier |
| URSP | WTRU (UE) Route Selection Policy |

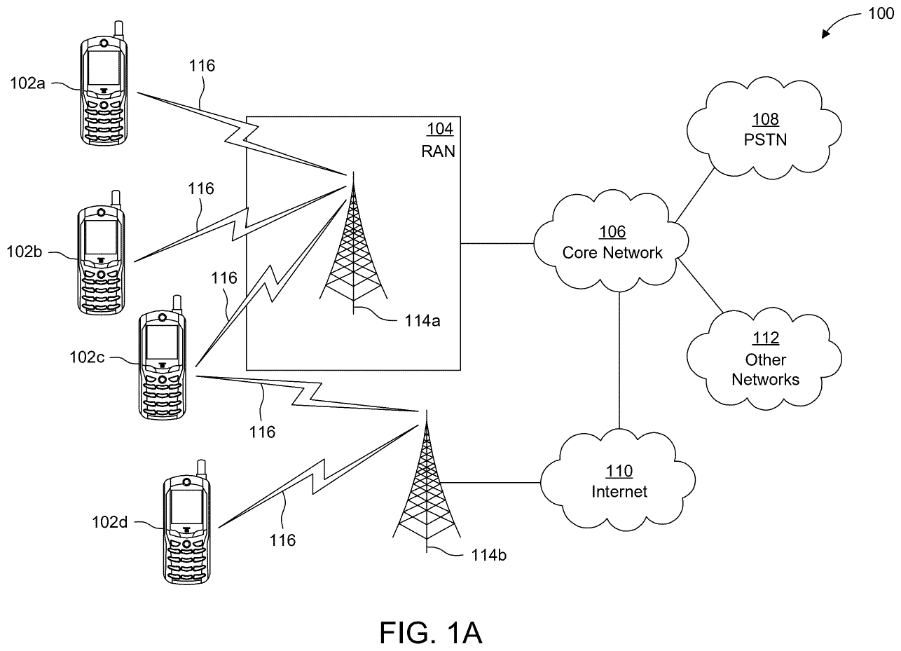

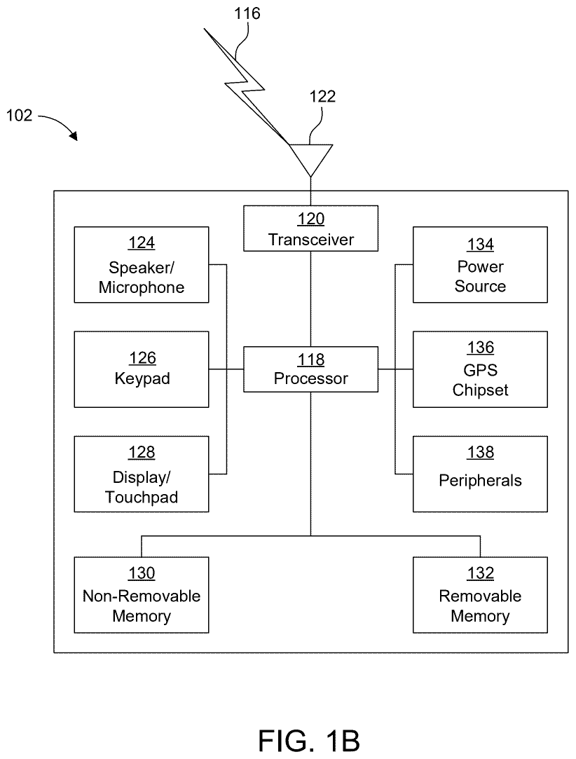

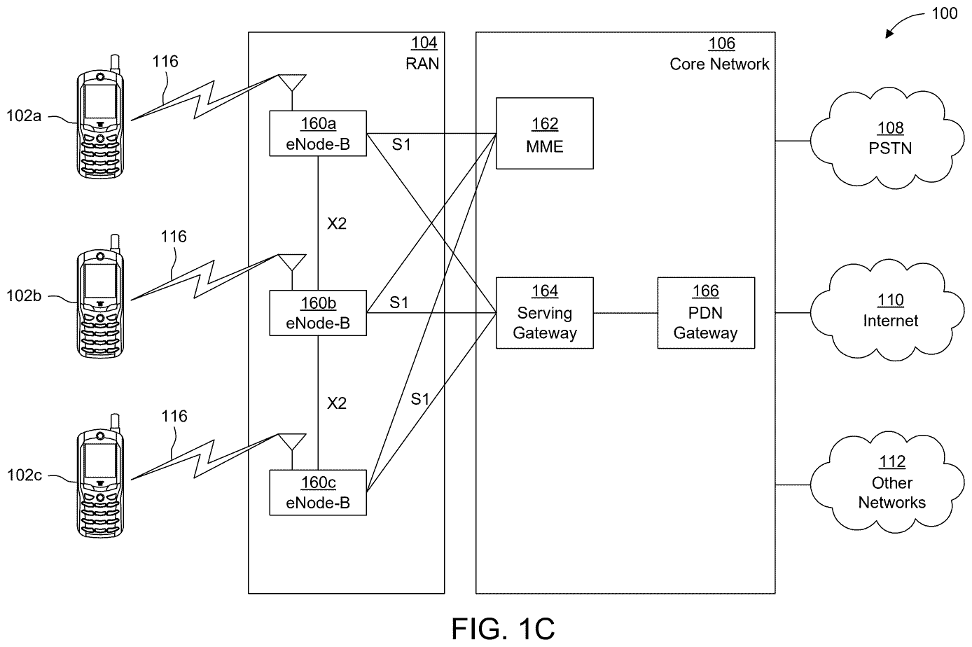

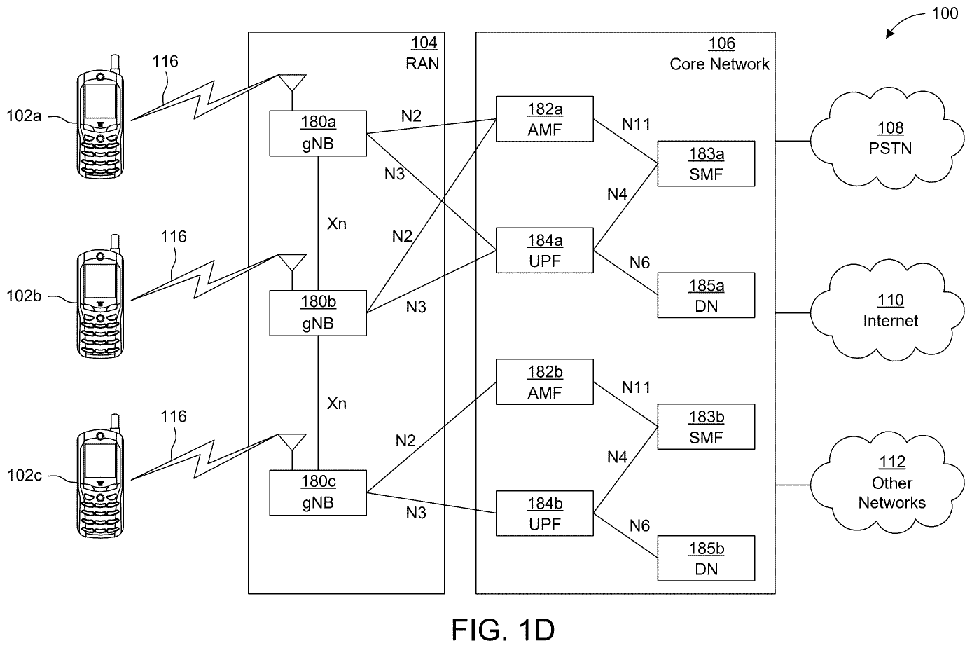

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184a, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Various techniques of this disclosure describe how a wireless transmit/receive unit (WTRU), e.g., a user equipment (UE) may interwork with a network, e.g. a data collection network and/or a data delivery network, based on a configuration by a mobile network and/or an application function. The WTRU may function as a publisher, e.g. a data collection publisher and/or a data delivery network publisher, a subscriber and/or a forwarder etc., for example. The WTRU may be configured to connect to a peer, e.g. a data collection peer and/or a delivery network peer, to announce one or more namespaces to the peer, to accept one or more subscriptions from the peer, to trigger data collection based on the one or more subscriptions, and/or to transmit one or more data objects corresponding to one or more subscribed streams. The WTRU may also be configured to receive and/or forward one or more namespace announcements, the one or more subscriptions and/or the one or more data objects. The WTRU may also send and/or transmit the one or more subscriptions and receive the one or more data objects corresponding to the one or more subscribed streams.

Various embodiments of the present disclosure relate to a core network (CN), a sixth generation (6G) user plane and/or quality of service (QoS) in wired and/or wireless communication networks.

An embodiment of the present disclosure relates to one or more policies (e.g., in a WTRU and/or a policy control function (PCF) etc.) for one or more data collection and delivery network (DCDN) operations, which may be transmitted using one or more procedures.

An embodiment of the present disclosure relates to a WTRU behavior for collecting and/or delivering one or more data streams.

An embodiment of the present disclosure relates to an updated protocol data unit (PDU) session establishment and/or modification procedure to connect to the DCDN.

An embodiment of the present disclosure includes that the network configures the WTRU to connect to the DCDN.

An embodiment of the present disclosure relates to one or more events that trigger a procedure for the WTRU to connect to the DCDN.

An embodiment of the present disclosure relates to the WTRU connecting to the peer, based on a DCDN configuration.

An embodiment of the present disclosure relates to the WTRU functioning as the publisher that announces the one or more namespaces, receives the one or more subscriptions, triggers one or more measurements and sends the one or more measurements, for example.

An embodiment of the present disclosure relates to the WTRU functioning as the subscriber that subscribes to the one or more data streams and receives them.

An embodiment of the present disclosure relates to the WTRU functioning as the forwarder that forwards the one or more announcements, subscriptions and/or data streams between the one or more peers.

The term RAN node may be used herein to represent any radio access network (RAN) node including a gNodeB and eNodeB etc., for example

The terms application server (AS) and application function (AF) may be used interchangeably herein. An AS may be and/or include an edge application server (EAS), for example.

The term information element (IE) may be used herein to represent one or more parameters. An IE may be made up of one or more other IEs, for example.

The term user plane function (UPF) used herein may designate a PDU Session anchor (PSA) UPF and/or an intermediate UPF, for example.

In some embodiments, a service data flow (SDF) is and/or includes a data flow (e.g., as identified in 3GPP 5G standards by specific characteristics, such as a 5-tuple composed of a transport protocol, source and destination IP addresses and ports etc.) that is subject to specific quality of service and/or policy control rules, for example.

In an embodiment, the WTRU (e.g. the UE and/or the RAN node etc.) may function as a DCDN publisher node.

In an embodiment, a method performed by a WTRU is provided. In the method, a CN node and/or a RAN node may send an indication to a WTRU, to collect and send data through a DCDN. The indication includes one or more DCDN configuration IEs, which may be included in a control plane (CP) (e.g., non-access stratum (NAS)) message and/or a user plane (UP) message and/or a DCDN policy rule.

In an embodiment, a trigger is provided. The WTRU may receive a trigger to connect to a DCDN peer. In an example, the trigger may be a message and/or a different DCDN trigger such as a network registration and/or a WTRU relocation event and/or running a WTRU application. In an example, the trigger may also include to announce a namespace, but it is also possible that the decision to announce the namespace come later, e.g., from a WTRU application. In an embodiment, a connection to DCDN peer is provided. The WTRU may establish a PDU session and/or a D2D link based on the one or more DCDN configuration IEs. The WTRU may connect to the DCDN peer based on the one or more DCDN configuration IEs, over the PDU session and/or the D2D link.

In an embodiment, the WTRU may function as a DCDN publisher node. The WTRU may send an announcement message including a namespace. In an example, the namespace may be explicit in the one or more DCDN configuration IEs, or it may be provided by a WTRU application and/or software component. The WTRU may receive a subscription message, from the DCDN peer, including a data stream ID. The WTRU may determine if it accepts the subscription to the data stream ID based on the one or more DCDN configuration IEs, e.g., including checking whether it corresponds to a valid data stream, whether it is consented by the user, whether it matches a service threshold etc. The WTRU may initiate data collection corresponding to the data stream ID, based on the DCDN configuration IEs.

The WTRU may send a subscription response message, to the DCDN peer, including a data stream ID, indicating that the subscription is accepted. The WTRU may send a message to the DCDN peer, including a data object and the data stream ID and/or a reference to the data stream ID.

In an embodiment, a method performed by a RAN node is provided. The indication may be from a CN node and/or an operations, administration, and maintenance (OAM) function. The RAN node may establish a connection to an IP network (e.g. instead of a PDU session and/or a D2D link etc.). The connection to the DCDN peer is over the IP network. The RAN node may initiate data collection corresponding to the data stream ID, by sending a message to the WTRU, based on the one or more DCDN configuration IEs (which may include an ID of the WTRU, as a data source). The RAN may receive a message from the WTRU including the IE and send this IE in the data object, to the DCDN peer.

In an example, the WTRU may function as a DCDN forwarder node.

In various embodiments of the present disclosure, a CN node and/or an RAN node may send an indication to the WTRU, to forward one or more data streams through a DCDN. The indication include one or more DCDN configuration IEs, which may be included in a CP (e.g., a NAS) message and/or a UP message and/or a DCDN policy rule. The one or more DCDN configuration IEs may indicate two DCDN peers, for example.

In various embodiments of the present disclosure, the WTRU may receive a first trigger to connect to a first DCDN peer. The WTRU may establish a PDU session based on the one or more DCDN configuration IEs. The WTRU may connect to the first DCDN peer over the PDU session, based on the one or more DCDN configuration IEs.

In various embodiments, the WTRU may receive a second trigger to connect to a second DCDN peer. The WTRU may establish a D2D link based on the one or more DCDN configuration IEs. The WTRU may connect to the second DCDN peer over the D2D link, based on the one or more DCDN configuration IEs.

In various embodiments of the present disclosure, the WTRU may receive an announcement message from the second DCDN peer, including a namespace. The WTRU may determine if it accepts the announcement, based on the one or more DCDN configuration IEs, e.g., including checking whether it corresponds to an allowed namespace, whether it is consented by the user, whether it matches a service threshold. If the announcement is accepted, the WTRU may configure a forwarding rule for one or more subscriptions related to the namespace. The WTRU may forward the announcement message to the first DCDN peer. The WTRU may receive a subscription message from the first DCDN peer. The WTRU may determine if it accepts the subscription, based on the one or more DCDN configuration IEs, e.g., including checking whether there is a matching forwarding rule for subscriptions, whether it corresponds to an allowed namespace or data stream ID, whether it is consented by the user, whether it matches a service threshold. If it is accepted, the WTRU may configure a forwarding rule for data objects associated with the data stream ID. The WTRU may forward the subscription message to the second DCDN peer, based on the forwarding rule for subscriptions. The WTRU may receive a data object from the second DCDN peer, including a data stream ID or a reference to the data stream ID. The WTRU may forward the data object to the first DCDN peer, based on the forwarding rule for one or more data objects associated with the data stream ID.

In various embodiments of the present disclosure, the WTRU may function as a DCDN subscriber node. A CN node and/or an RAN node may send an indication to a WTRU, to subscribe to one or more data streams through a DCDN. The indication includes one or more DCDN configuration IEs, which may be included in a CP (e.g., a NAS) message and/or a UP message and/or a DCDN policy rule etc.

The WTRU may receive a trigger to connect to a DCDN peer. The WTRU may establish a PDU session or D2D link based on one or more DCDN configuration IEs. The WTRU may connect to the DCDN peer over the PDU session, based on the one or more DCDN configuration IEs.

In various embodiments of the present disclosure, the WTRU may function as a DCDN subscriber node. The WTRU may receive, from a WTRU application and/or a software component, a request to subscribe to a data stream ID.

The WTRU may determine if it accepts the announcement, based on one or more DCDN configuration IEs, e.g., including checking whether it corresponds to a valid data stream, whether it is consented by the user, whether it matches a service threshold. The WTRU may select the destination DCDN peer for the subscription, based on the one or more DCDN configuration IEs. The WTRU may send a subscription message to the selected destination DCDN peer. The WTRU may receive, from the peer, a subscription response message, including a data stream ID, indicating that the subscription is accepted. The WTRU may receive, from the peer, a data object including a data stream ID or a reference to the data stream ID.

Typically, for data collection in a mobile network, applications in extended reality (XR), ambient internet of things (IoT), sensing, and/or automotive domains may have multiple devices operating together while inter-connected with each other, in distributed or centralized manner. Various data collection mechanisms are needed for those applications, and for the operation of the mobile networks using artificial intelligence (AI)/machine learning (ML). These data collection mechanisms are needed for data emitted by multiple data sources, some of which are connected to the network through a WTRU, and some of which are WTRUs. Some devices can communicate with each other via non-3GPP (e.g., WiFi, Bluetooth, USB-C etc.) or 3GPP (e.g., PC5, Uu etc.) interfaces. If the device is a WTRU (e.g., Uu and PC5 capable), then it may establish a direct connection with the network (e.g., Uu) or via another device (e.g., relay over PC5). If the device is a non-3GPP device (e.g., inter-connected via WiFi and/or USB-C) then it may rely on the 3GPP WTRU to communicate with the MNO or with an application server (AS), e.g., if quality of experience (QoE) related data needs to be sent to train one or more AI models.

In an example, a “data stream” may include a set of IEs emitted by such interconnected devices and communicated over the mobile network to various consumers that may be components of the mobile network and/or applications interworking with the mobile network. Furthermore, network nodes such as WTRUs, RAN node, UPF, and/or CN NFs etc. may also send various data streams that are relevant to the consumers such as AI applications and/or components running on other WTRUs, RAN nodes, and/or CN NFs etc.

In an example, media over QUIC (MOQ) is a protocol, that is designed to stream media and other data, with web-like security and scaling, and with a latency that can be adapted to the network. MOQ is an example data streaming protocol based on a publish-subscribe mechanism. The mechanisms, methods and/or systems described herein may be used with other data streaming protocols based on a publish-subscribe mechanism, such as MQTT, or such as a pubsub Web service protocol based on WebSocket and JSON etc., for example.

In an example, a primary use case for MOQ is low-latency video streaming, however it may be used to stream other types of data such as texts and/or IoT data. A key feature of MOQ is the publish-subscribe mechanism it is based on. This mechanism enables a CDN to be used for scaling and/or caching. A CDN node may function as a MOQ client (e.g., to the origin and/or another CDN node) and a MOQ server (e.g., to a client and/or another CDN node). The CDN nodes may typically be connected in a hierarchical network. The CDN nodes may cache content. The CDN nodes may fan out the distribution of one or more streams in a hierarchical network, ensuring that only the CDN nodes which have active subscriptions receive the content.

A content publisher may prepare a catalog of one or more track identifiers, and make this catalog available to one or more clients, e.g., within the MOQ protocol, and/or through other means such as application layer signaling etc., for example. A client may obtain a track identifier through a catalog and/or other, e.g., application specific, means. A URL identifying a track may be translated into a track full name for use within the MOQ protocol, where a track full name is composed of a namespace, which is a tuple of bytes, and a track name, which is a string, for example. For example, a track identified as “moqt://fqdn1/application1/stream1” may be translated into a namespace (“fqdn1”, “application1”) and a track name “stream1”, which corresponds to the track full name [(“fqdn1”, “application1”), “stream1”]. In an example, in some systems, the encoding of namespace and track names may be different, e.g., a single tuple where the last element of the tuple is the track name. In an example, in some systems, a track alias may be transmitted in the data objects, rather than a track full name.

An endpoint node may send an ANNOUNCE message to another endpoint node, to indicate it is willing to stream tracks within a namespace included in the ANNOUNCE message. In some systems, an endpoint node may announce a data stream ID instead of a namespace, e.g., by sending a PUBLISH message to another endpoint node, to indicate it is willing to stream a track with a data stream ID provided in the PUBLISH message (e.g., the PUBLISH message may include a track full name). In an example, one or more procedures described herein include announcement messages that include a namespace (e.g., ANNOUNCE messages), however the announcement messages in these procedures may be replaced with announcement messages that include a data stream ID (e.g., PUBLISH messages). An endpoint node may send a SUBSCRIBE request message (also referred to as SUBSCRIBE message herein) to another endpoint node. The SUBSCRIBE message includes a track full name. The SUBSCRIBE message is forwarded through any number of CDN nodes and/or servers, towards the origin of the track. Once the SUBSCRIBE reaches a node which is the origin and/or has a copy of the track content, the node may accept the subscription, reply with SUBSCRIBE_OK response message, and start streaming the data objects of the track (or, in case of error, reply with a SUBSCRIBE_ERROR response message). A SUBSCRIBE message between two DCDN nodes may include a track alias, and the data objects corresponding to this subscription between the two nodes may include the track alias. In an example, using a track alias in data objects efficiently replaces including a full track name in the data object. A track alias is a reference to a full track name. Each DCDN node on the path of the data object may retrieve the subscription information corresponding to an incoming data object, based on the track alias in the data object. Each DCDN node on the path of the data object may set the value of the track alias on outgoing (e.g., forwarded) data objects, based on the subscription associated with the data object.

One or more use cases for data collection and/or distribution in mobile networks include measurements (from the WTRU) and AI model updates (to the WTRU and/or RAN node) for AI/ML applications for the following NR air interface aspects: channel state information feedback enhancement (e.g., overhead reduction, improved accuracy, prediction); beam management (e.g., beam prediction in time, and/or spatial domain for overhead and latency reduction, beam selection accuracy improvement); positioning accuracy enhancements for different scenarios including, e.g., those with heavy non-line of sight conditions.

The network (e.g., RAN node and/or CN node) may configure the WTRU to take one or more measurements for a use case (e.g., beam forming, channel state information and/or positioning). The WTRU may generate the measurements and the endpoint nodes that uses the measurements may include a RAN node, the OAM system or an over-the-top (OTT) server, e.g., an application function (AF) or a network function (NF). An endpoint node may train an AI model using the WTRU measurements and transmit AI model updates to the consumer of this model update, e.g., a WTRU and/or a RAN node etc.

Other use cases for collecting and/or distributing data in a mobile network include measurements from RAN nodes used by AI/ML applications for optimizing aspects of the mobile network, or core network nodes generating and distributing event notifications to other core network or RAN nodes.

In conventional data collection and/or data delivery systems, data collection and delivery between WTRUs, WTRUs and NF, WTRUs and AS, and WTRUs and RAN nodes can be inefficient. A point-to-point delivery between data source and data consumer leads to traffic duplication (e.g., sending 10 copies of a measurement to 10 consumers). A routing through a dedicated NF leads to scaling and single point of failure issues, and which can fail to leverage existing technology and infrastructure. Therefore, mechanisms and procedures need to be in place to efficiently deliver data, such as device measurements for AI/ML applications, and AI/ML model updates to devices, and to deliver event notifications, without having to send multiple copies of the same data.

Various embodiments of the present disclosure describe how the mobile network and the WTRU should interwork with a DCDN integrated with the mobile network. A DCDN may have data delivery (i.e., the core functionality) to enable the consumers to receive the data streams that it requests and is allowed to receive. A DCDN may reduce infrastructure costs, share CDN infrastructure between mobile network and applications, to scale efficiently with the number of streams, publishers and consumers, and to enable caching data streams when applicable. A DCDN may have efficient routing to efficiently route the data streams through the network (including 3GPP and non-3GPP segments). A DCDN may have priority handling to handle priorities between the streams in case of congestion. A DCDN may be on-demand, e.g. the data sources may only emit data streams that are consumed.

The DCDN (also called “distribution network” or “DCDN network” herein) is a network of interconnected nodes that enable the collection and distribution of data. The DCDN network may use a publish-subscribe based protocol, called herein a DCDN protocol (e.g., MOQ or MQTT), for example.

The DCDN network may be used as a new data plane for the mobile networks, which may be composed of a set of network functions and interfaces that are dedicated to transmitting streams of data between nodes within the mobile network, and which may be distinct from the user plane and control plane, or which may be built over the user plane and/or control plane.

The unit of distribution in a DCDN is the DCDN data stream (also called “data stream” herein), which is a unidirectional stream of data objects. A data object may be a message including a unit of application data. A data object message is identified by an object ID. A data object may be transmitted in one or more PDUs. When using the MOQ protocol, the data stream may be a MOQ track, and the data object may be a MOQ object, for example. Each data stream has a data stream ID, which may be, e.g., a MOQ full track name, which is composed of a tuple of bytes and a sequence of bytes, such as (“network-id1”, “ue-id1”, “app-id1”) and “measurement-type”. In other examples, a data stream ID may be a string, a URL, or a URI etc.

A DCDN namespace (also called “namespace” herein) is a data stream ID prefix. For example, a DCDN namespace may be a MOQ track namespace, which is a tuple of bytes. In other examples, a DCDN namespace may be a string, URI prefix and/or URL prefix etc. A data stream belongs to a namespace if its data stream ID includes the namespace, e.g., as a prefix. For example, the data stream ID identified by [(“network-id1”, “ue-id1”, “app-id1”) and “measurement-type”] belongs to the namespace (“network-id1”, “ue-id1”) but not to the namespace (“network-id1”, “ue-id2”). In an example, for transmission efficiency, a data object may include a reference to a data stream ID (e.g., a MOQ track alias), rather than the data stream ID itself. The reference to the data stream ID may be negotiated on a hop-by-hop basis (e.g., between each interconnected DCDN on the path of a subscription), e.g., in subscription requests and response messages. Herein the term data stream ID may refer to the data stream ID or to a reference to the data stream ID.

A DCDN NF is an NF that includes support for pubsub protocol (e.g., a MOQ relay) and/or includes logic for forwarding subscriptions, announcements and/or data streams etc. A device that includes a DCDN NF may function as a DCDN forwarder, i.e., a node in a DCDN network, that forwards subscriptions, announcements and/or data streams etc.

A DCDN NF may be in a CDN node. For example, a third-party CDN network may deploy one or more DCDN NFs in one or more DNs near mobile network base station sites or cell sites.

A DCDN NF may be a core network function in a core network NF, or a functionality that is provided by a UPF. For example, an operator may deploy one or more DCDN NFs in its own network. For example, an operator may deploy a DCDN NF in a UPF, e.g., a UPF with a MOQ relay functionality. The MOQ relay functionality of a UPF may be used both for enabling DCDN and for enabling existing high data rate low latency services for XR and interactive media services.

A DCDN NF may be in a WTRU. For example, a WTRU functioning as a WTRU-to-network relay may act as a forwarder for the data streams from another WTRU connected over a sidelink.

A DCDN NF may be in a RAN node. For example, a RAN node may function as a forwarder for the data streams from a WTRU and received from the WTRU in layer-2 messages.

The one or more DCDN NFs may be managed and controlled by one or more OAM servers and/or one or more control plane NFs.

A DCDN client (also called “client” herein) is a node that connects to a DCDN NF to get access to the distribution network. The DCDN client may publish and consume the data streams through the DCDN NF. To publish the data streams, the client may announce one or more namespaces to the DCDN (e.g., sends MOQ ANNOUNCE messages) and transmit one or more data streams to the subscribers. To consume data streams, the client may subscribe to the one or more data streams with the DCDN (e.g., sends MOQ SUBSCRIBE messages) and/or receive the one or more data streams from the publishers.

A DCDN node is a network device that is or includes a DCDN NF and/or DCDN client. A DCDN node may be, e.g., a WTRU, a UPF, a CDN proxy server, an AS, an NF, a core network NF, and/or a RAN node etc. A DCDN node may act as a DCDN subscriber node (which subscribes to data streams), a DCDN publisher node (which publish data streams), a DCDN forwarder node (which forwards announcements, subscriptions and data streams), or a combination of those roles, for example.

A data source is a program, application, or software component that generates a data stream. A DCDN publisher node includes one or more data sources. A data source may be a software entity running on a DCDN node, which generates one or more data objects. For example, a WTRU may generate a data stream based on the one or more data objects generated by a WTRU application, and/or a software component on the WTRU etc. A data stream may receive the one or more data objects from another node, e.g., over a point-to-point protocol. For example, a RAN node may include a data source that generates a data stream including one or more IEs that it receives from a WTRU over a layer-2 protocol. In another example, a data source on a WTRU may generate a data stream based on the one or more data objects received from a device connected to the WTRU over a wireless protocol such as Bluetooth. In an example, a DCDN node may encode and/or modify the one or more data objects generated by a data source (e.g., on the DCDN node) and transmit one or more encoded data objects. For example, a WTRU (e.g., the DCDN node) may encode a MOQ data object including a measurement IE generated and/or received from a software component on the WTRU (e.g., the data source). In an example, the data source may generate a data object which is a measurement IE, and the DCDN node may generate a data object which is a MOQ data object message. In an example, an encoded and/or modified data object transmitted by the DCDN node may be derived from a data object generated by the data source. In another example, the data objects emitted by the DCDN node and data source may be the same, e.g., the DCDN node may transmit a message comprising the data object generated by the data source.

A data consumer is a program, application and/or software component that consumes a data stream. A DCDN subscriber node includes one or more data consumers.

A DCDN connection is a connection between two DCDN nodes. For example, a DCDN connection may be a MOQ transport connection. From the point of view of a DCDN node “A”, a DCDN peer (also called “peer” herein) is a DCDN node that terminates a direct DCDN connection with the node “A”. For example, when the DCDN protocol is MOQ, the peers are MOQ endpoints. For example, for a WTRU, a DCDN peer may be a server including but not limited to a DCDN NF, a CDN node including a DCDN NF, a UPF including a DCDN NF, and/or a WTRU including a DCDN NF etc. For example, for a RAN node and/or a CN node, a DCDN peer may be a server including a DCDN NF and/or a CDN node including a DCDN NF etc.

A plurality of DCDN NFs and clients can be interconnected (e.g., over the IP protocol) to build a distribution network (called herein the DCDN or DCDN network). To inter-connect (e.g., in a CDN domain or mobile network domain) the plurality of DCDN NFs may be configured with the FQDN or IP address of peer DCDN NFs and establish long term connections with their peer DCDN NFs. To inter-connect (e.g., over the N6 interface), a DCDN NF or client may discover DCDN NFs using the DNS system or using an edge computing framework.

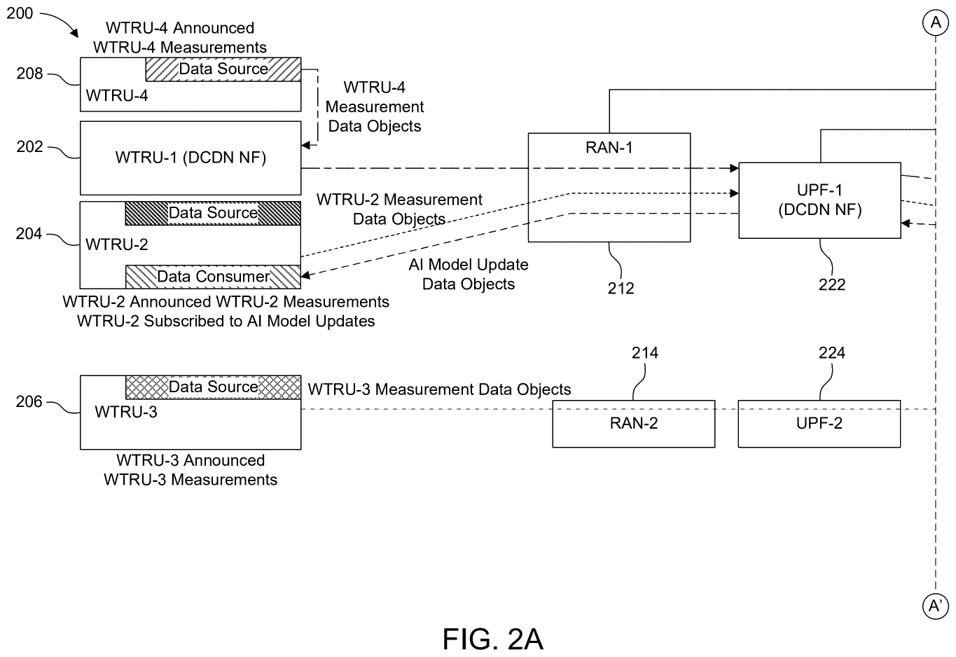

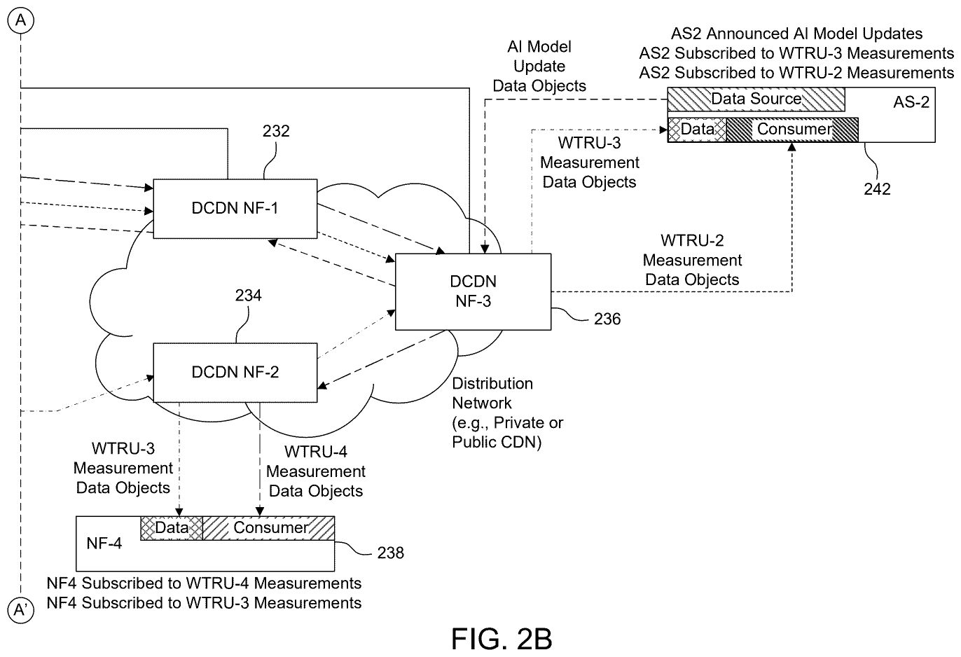

Referring now to FIGS. 2A-2B, an example DCDN architecture is shown according to one or more embodiments. A DCDN architecture 200 includes a first WTRU (WTRU-1) 202, a second WTRU (WTRU-2) 204, a third WTRU (WTRU-3) 206, a fourth WTRU (WTRU-4) 208, a first RAN (RAN-1) 212, a second RAN (RAN-2) 214, a first UPF (UPF-1) 222, a second UPF (UPF-2) 224, a first NF (DCDN NF-1) 232, a second NF (DCDN NF-2) 234, a third NF (NF-3) 236, a fourth NF (NF-4) 238, and an application server (AS-2) 242.

In FIGS. 2A-2B, the WTRU-2 204, the WTRU-3 206, the WTRU-4 208, the AS-2 242 and the NF-4 238 are DCDN clients. The WTRU-1 202, the UPF-1 222, the NF-1 232, the NF-2 234, the NF-3 236 include a DCDN NF. A DCDN connection has been established between each DCDN client and one of the DCDN peers including a DCDN NF. The WTRU-1 202 and the WTRU-2 204 are connected to the network through the radio access network node RAN-1 212 and through the UPF UPF-1 222. The WTRU-3 206 is connected to the network through the radio access network node RAN-2 214 and through the UPF UPF-2 224.

The WTRU-3 206 publishes one or more measurements, e.g., by sending an ANNOUNCE message with a namespace that includes one or more data stream IDs for the one or more measurements. The WTRU-3 206 sends the ANNOUNCE message to the peer, here DCDN NF-2 234. The DCDN NF-2 234 propagates the announcement to the DCDN NF-3 236 (e.g., because the DCDN NF-3 236 may have subscribed to one or more announcements matching the namespace). The DCDN NFs build one or more forwarding tables including one or more namespaces from one or more announcements, which enables one or more routing subscriptions (e.g., towards a peer that announced a namespace that matches the subscription's data stream ID). The DCDN NFs build the one or more forwarding tables including one or more data stream IDs from subscriptions, which enable one or more routing data objects (e.g., towards a peer that subscribed to the data stream ID included in the data object). When the WTRU-3 206 receives a subscription message for its measurements, the data source generates a measurement data stream, which the WTRU-3 206 sends to the DCDN NF-2 234.

The WTRU-2 204 publishes measurements by sending an ANNOUNCE message to the peer it is connected to, here the UPF-1 222. The UPF-1 222 can be a peer because it includes a DCDN NF. The WTRU-2 204 also subscribes to the AI model updates by sending a SUBSCRIBE message to the UPF-1 222. The WTRU-4 208 publishes its measurements to the WTRU-1 202 by sending an ANNOUNCE message to the WTRU-1 202. The WTRU-1 202 forwards the ANNOUNCE message from the WTRU-4 208 to the UPF-1 222. The NF-4 238 subscribes to measurements from the WTRU-4 208 and the WTRU-3 206 by sending a SUBSCRIBE message for each stream to the DCDN NF-2 234. The AS-2 242 is an AI server that uses the WTRU measurements to train an AI model and then transmits AI model updates to the WTRUs. The AS-2 242 publishes a data stream of AI model updates, e.g., the AS-2 242 announces a namespace including the AI model updates data stream ID and is ready to send the AI model updates data stream to subscribers. The AS-2 242 also subscribes to measurements from the WTRU-2 204 and the WTRU-3 206. The announcements and subscriptions are propagated (e.g., forwarded) through DCDN NFs (the WTRU-1 202, the UPF-1 222, the DCDN NF-1 232, the DCDN NF-2 234 and the DCDN NF-3 236), which each updates forwarding tables for subscriptions and data objects.

The WTRU-3 206 sends to the DCDN NF-2 234 a measurement data stream generated by the data source on the WTRU-3 206. There is a single copy of the measurement data objects sent by the WTRU-3 206 through the RAN-2 214. The DCDN NF-2 234 duplicates the data objects to forward them to multiple recipients, the NF-4 238 and the DCDN NF-3 236. The DCDN NF-3 236 forwards the data stream to the AS-2 242.

The WTRU-4 208 sends, to the WTRU-1 202, a measurement data stream generated by the data source on the WTRU-4 208. The measurement data objects of the stream are successively forwarded through the WTRU-1 202, the UPF-1 222, the DCDN NF-1 232, the DCDN NF-3 236, and the DCDN NF-2 234. The DCDN NF-2 234 forwards the data objects to the NF4 238.

The WTRU-2 204 sends, to the WTRU-1 202, a measurement data stream generated by the data source on the WTRU-2 204. The UPF-1 222 forwards the data stream to the DCDN NF-1 232, which forwards the data stream to the DCDN NF-3 236, which forwards the data stream to the AS-2 242.

The UPF-1 222 and the RAN node RAN-1 212 are connected, e.g., over an IP network, to the DCDN NF-1 232 and the DCDN NF-2 234, respectively. This enables the UPF-1 222 and the RAN-1 212 to publish and subscribe to the data streams through the distribution network. The RAN-1 212 and the UPF-1 222 may therefore include data sources that generate data streams (e.g., measurements or events) that the RAN-1 212 and the UPF-1 222 transmit to subscribers through the DCDN network.

The DCDN NF-1 232, the NF-2 234 and the NF-3 236 may be part of a private or public CDN infrastructure, which enables using off-the-shelf CDN servers with support for a pubsub protocol such as MOQ. This infrastructure is suitable for low-latency streamed data such as measurements for AI/ML applications, or for event notifications from CN nodes or RAN nodes. This infrastructure can also be used for applications using the mobile network, such as video applications.

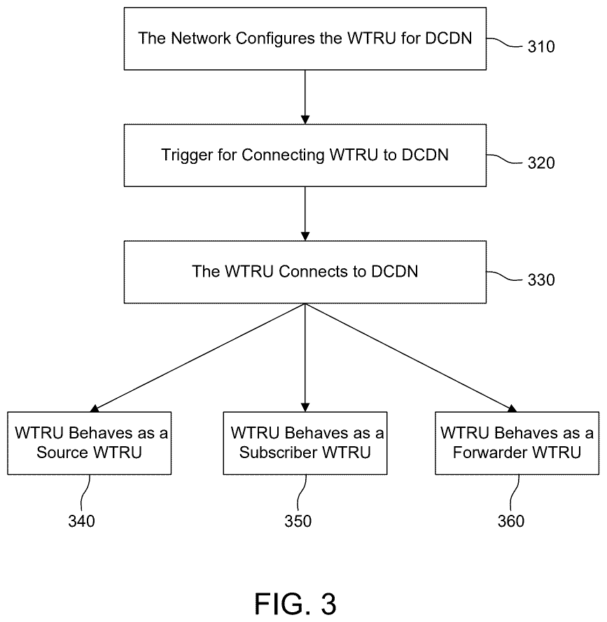

Referring now to FIG. 3, a flow diagram for an example method of a DCDN operation is shown according to one or more embodiments.

FIG. 3 describes the one or more aspects of a technique for integrating a WTRU with a DCDN, as a DCDN publisher, DCDN consumer and/or as a DCDN forwarder. In an example, the WTRU is an example DCDN node. One or more methods and procedures are described herein with an example of the WTRU as the DCDN node, and other methods and procedures may be derived for other DCDN nodes such as a RAN node, a UPF, a NF, and/or a AS etc., for example. In a first aspect, at 310, the network configures the WTRU to connect to a DCDN. In a second aspect, at 320, an event occurs, that triggers a procedure for the WTRU to connect to a DCDN. In some systems, the first and second aspects of 310 and 320 may occur together. In some systems, the first aspect of 310 may occur before the second aspect of 320. In some systems, the second aspect of 320 may occur before the first aspect of 310. In a third aspect, at 330, the WTRU connects to a peer, based on the configuration from the first aspect. In an example, from this point on, the WTRU may act according to a combination of the behaviors described in the fourth, fifth and sixth aspects. The WTRU may act as a publisher (e.g., a fourth aspect at 340) that announces namespaces, receives subscriptions, trigger measurements and send measurements. The WTRU may act as a subscriber (e.g., a fifth aspect at 350) that subscribes to data streams and receive them. The WTRU may act as a forwarder (e.g., a sixth aspect 360) that forwards announcements, subscriptions and/or data streams.

The one or more DCDN configuration IEs may be provided by the network to the DCDN node (e.g., WTRU) to enable the DCDN node to interoperate with the DCDN system. As described herein, one or more “DCDN configuration IEs” may also be referred to as one or more “DCDN IEs”.

In an example, a set of DCDN configuration IEs is one or more DCDN configuration IEs, which may be communicated to the WTRU in a control plane message (e.g., a NAS message such as but not limited to a registration response, or a PDU session establishment and/or modification response, or a configuration update command message, and/or another NAS message etc.). The set of DCDN configuration IEs may be communicated to the WTRU in a user plane message (e.g., metadata associated with a flow or a PDU session, which may for example indicate the IP address of a suitable peer). The set of DCDN configuration IEs may be communicated to the WTRU in a DCDN policy rule, which is a policy rule including the set of DCDN configuration IEs described herein. The DCDN policy rule may be configured on the WTRU by the network or a WTRU application (e.g., a new DCDN policy, and/or a new section of a URSP rule). A DCDN policy rule may be configured in the network (e.g., PCF) by an operator or an AF (e.g., a new DCDN policy and/or a new section of a PCC rule).

The set of DCDN configuration IEs indicates to the DCDN node (e.g., the WTRU) to perform one or more actions related to the DCDN network when a DCDN trigger is received and may provide parameters applicable to the action. For example, a DCDN policy rule indicates to the DCDN node to perform one or more actions when the DCDN node evaluates that a trigger in the rule is activated. In another example, the set of DCDN configuration IEs indicates to the DCDN node to perform one or more actions when the set of DCDN configuration IEs is received, in a message, by the DCDN node.

An example list of actions indicated by the set of DCDN configuration IEs (e.g., by the DCDN policy rule) is provided here. Further details on the actions and related parameters are described below, where a DCDN message may be any DCDN protocol message, including an announcement, subscription, or data object: establish and/or reuse a PDU session for a DCDN connection; establish and/or reuse a D2D connection for a DCDN connection; establish and/or reuse a DCDN connection to a peer; store a DCDN policy rule, e.g., in the PCF, NF, WTRU, RAN node; determine which peer to connect to; discover a peer to connect to; act as a DCDN publisher, subscriber and/or forwarder, e.g., for certain applications or namespaces; configure a DCDN NF, e.g., as a DCDN forwarder, and with QoS information; start or stop the generation of a data stream, e.g., by an application or software component on the DCDN node; send an DCDN message; determine which peer to send a DCDN message; accept to process a received DCDN message, e.g., based on allowed namespace, allowed data stream ID, user consent, service threshold; and/or accept to send or forward a DCDN message, e.g., based on namespace, data stream ID, user consent, service threshold etc.

In an example, a DCDN configuration IE (e.g., a DCDN indication IE) may include a DCDN indication indicates that an operation is for connecting to a DCDN network.

In an example, a WTRU may include a DCDN indication in a PDU session establishment or modification request, to indicate to the network that the request is for DCDN connectivity. The network (e.g., a SMF, a 6G RAN Node, and/or any NF that performs UPF selection etc.) may use the indication to select a UPF that supports DCDN connectivity (e.g., includes a DCDN NF or is interconnected with a DCDN NF).

In an example, a DCDN configuration IE (e.g., a DCDN connectivity IE) may include DCDN connectivity information including one or more parameters for establishing a user plane connection to a peer.

In an example, the DCDN connectivity information includes one or more parameters for a DNN for a PDU session to a peer. A network slice type indication (e.g., a S-NSSAI) for a PDU session that will be used to communicate with a peer. For example, a network slice may be dedicated to the DCDN network, e.g., a data plane network slice. The DNN and network slice may be configured in a URSP rule (e.g., a URSP rule including a “DCDN” application ID), or in a new DCDN policy rule.

In an example, the DCDN connectivity information includes one or more parameters for serving network information, which indicates the identities of one or more serving networks that the WTRU may use to communicate with the DCDN. For example, the serving network information may include one or more PLMN IDs. The serving network information may indicate to the that the WTRU may only communicate with the DCDN when the WTRU is served by one or more of the one or more identified PLMNs. The WTRU may be considered served by the PLMN when the WTRU is communicating via a base station that is associated with the PLMN.

In an example, the DCDN connectivity information includes one or more parameters for one or more QoS requirements (e.g., a 5G QoS identifier, an allocation and retention priority, one or more QoS parameters, one or more PDU Set QoS parameters, a packet loss rate, a maximum bit rate, a QoS rule, and/or a QoS profile etc.). The one or more QoS requirements may be configured in PCC rules associated with one or more DCDN connections.

In an example, the DCDN connectivity information includes one or more parameters for a DCDN bundling indication, which indicates that a set of DCDN configuration IEs (e.g., a set of DCDN policy rules) may reuse an existing compatible DCDN connection. A DCDN connection is compatible with a DCDN policy rule if they share the same peer information and DCDN connectivity information such as DNN or network slice.

In an example, the DCDN connectivity information includes one or more parameters for device-to-device (D2D) information, e.g., policies and parameters for proximity services (ProSe) discovery, to enable discovering and connecting to the WTRUs that may act as peers. The D2D information may include one or more of: WTRU IDs, group IDs, ProSe application layer ID, and/or ProSe identifier etc. The D2D information may include one or more “role” IEs, identifying the type of role that the identified WTRUs, and groups may have, including one or more DCDN publishers, consumers, forwarders, or a combination of these roles.

In some systems, the D2D information may be provisioned by a DCDN ProSe application server, which may enable a D2D connection between peers.

In an example, the DCDN connectivity information includes one or more parameters for IP network connectivity information, e.g., the identifier of a network interface to use to connect to an IP network for the DCDN traffic. For example, this may be sent by an OAM and/or a CN node, to a RAN node to enable the RAN node to connect to a DCDN peer through this interface.

In an example, the one or more DCDN configuration IEs (e.g., a DCDN peer IE) may include DCDN peer information (also called “peer information” herein), which includes an identifier and/or locator of a DCDN node, that enables connecting to this node.

In an example, the DCDN peer information may include an FQDN, an IP address, a transport protocol identifier (e.g., UDP), and/or a transport protocol port, which may be used to identify the peer to establish a transport layer connection to the peer.

In an example, the DCDN peer information may include DCDN protocol information that identifies an application layer protocol to use for connecting to the peer, e.g., MOQ, or another pubsub-based data delivery protocol such as MQTT. In some systems, multiple DCDN protocols may be used concurrently within a single DCDN network. For example, existing layer-2 protocols may be used between a RAN node and a WTRU, to stream measurements, while a transport layer protocol such as MOQ or MQTT may be used between other DCDN nodes.

In an example, the DCDN peer information may include a default destination indicator, which may indicate that the peer should be a default destination for one or more namespace announcements and/or subscription requests. For example, for a WTRU, a UPF and/or CDN node may be a default destination, since most subscribers and publishers should be reachable through the UPF and/or CDN node. For example, in a scenario where a first WTRU and a second WTRU have a D2D connection, and where the second WTRU is a WTRU-to-network relay for the first WTRU, the second WTRU may be a default destination for the first WTRU, and the first WTRU should not be a default destination for the second WTRU.

In an example of peer information usage, an SMF can send to the WTRU, in a PDU session establishment and/or modification response message, peer information comprising an IP address and a UDP protocol port, that describes how to connect to a MOQ relay on the UPF, where the MOQ relay acts as a peer.

In an example, peer information may be an FQDN, configured on the WTRU (e.g., in a DCDN policy deployed by the network on the WTRU). In this case, the WTRU may use the DNS system to obtain an IP address of a DCDN NF.

In an example, peer information may include an FQDN provided to the WTRU by a WTRU application, and the WTRU may use the DNS system to obtain an IP address of a DCDN NF.

In some systems, peer information provisioned on a DCDN node (e.g., WTRU) may be associated with a DCDN trigger, to indicate that the DCDN node should connect to the peer when the DCDN trigger is activated. For example, a DCDN policy deployed on the WTRU by the network may include a peer FQDN for sensing applications, and another peer FQDN for AI applications. This makes it possible to use different DCDN networks that have different properties in term of latency and data caching.

In some systems, the “default destination indicator” may be provided within the DCDN connection, where a DCDN NF that is already connected to a default destination DCDN NF may signal itself to be a default destination, to all other (non-default) peer.

In an example, the one or more DCDN configuration IEs (e.g., a DCDN namespace IE) may include a DCDN namespace (also called “namespace” herein), which is an identifier for a group of data streams. A namespace is used for routing subscriptions towards a DCDN node that may send the data streams inside the namespace. For example, a namespace may be a string (e.g., a URL) that is a prefix to all data stream IDs within the namespace. The network provisions one or more namespaces to a DCDN node (e.g., a WTRU), to indicate the one or more namespaces that the DCDN node should announce to the DCDN network, and/or the one or more namespaces that the DCDN node should accept for forwarding, and/or one or more namespace announcements that the DCDN node should subscribe to. A namespace may be associated with a DCDN trigger, e.g., to indicate that the DCDN node should announce the namespace when the DCDN trigger is activated.

In some systems, one or more DCDN configuration IEs may include one or more DCDN namespace fragments (also called “namespace fragments” herein), which are portions (e.g., suffixes) of a namespace. For example, a WTRU may generate a namespace or data stream ID based on an algorithm that uses the WTRU ID as an input, namespace fragment and data stream parameters. In a case where the network provides a namespace fragment <frag>, the WTRU may generate a namespace URL such as moqt://<UE ID>.<home network ID>/<frag>. The WTRU may generate a data stream ID URL such as moqt://<UE ID>.<home network ID>/<frag>/<datatype>/<precision>/<period>. In another example, the WTRU may generate a namespace or data stream ID based on an algorithm that uses the WTRU ID and the serving PLMN ID of the WTRU as an input, namespace fragment and data stream parameters. In a case where the network provides a namespace fragment <frag>, the WTRU may generate a namespace URL such as moqt://<UE ID>.<serving network ID>/<frag>. The WTRU may generate a data stream ID URL such as moqt://<UE ID>.<serving network ID>/<frag>/<datatype>/<precision>/<period>. The WTRU may determine its serving network identifier based on information that is received from a base station (e.g. broadcasted information or a temporary identifier that is assigned to the WTRU by the base station) or information that is received from a mobility management core network function (e.g. a temporary identifier that is assigned to the WTRU by the mobility management core network function).

In an example, the one or more DCDN configuration IEs (e.g., a DCDN role IE) may include DCDN role information, which indicates the role that a DCDN node (e.g., WTRU) may fulfill in a DCDN connection. Examples of possible values include but are not limited to publisher, consumer, forwarder or a combination of those values. A publisher may announce namespaces and receive subscription messages. A subscriber may send subscription messages and receive announcements messages and data objects. A forwarder may receive and send namespace announcement messages and may receive and send subscription messages. Forwarders are and/or include one or more DCDN NFs (e.g., it can propagate and/or route announcements and/or subscriptions), while publishers and consumers may be one or more DCDN clients and/or DCDN NFs.

In an example, the one or more DCDN configuration IEs (e.g., a DCDN publisher IE) may include DCDN publisher information, which describes how a DCDN publisher node handles incoming subscriptions and how to generate data streams.

In an example, DCDN publisher information includes a data source ID, which identifies a data source (defined hereinbefore). The data source ID may be a string, e.g., a URI or URL. The data source ID may be provided along with a namespace and/or namespace fragment that corresponds to the data source. The namespace fragment may be used to generate a namespace that corresponds to the data source. For example, a DCDN node may forward one or more subscriptions to a data source, if the data stream ID in the subscription is included in the corresponding namespace.

In some cases, for example, the data source is not collocated with (e.g., in the same node as) the DCDN node. For example, a RAN node may be configured with a data source ID identifying a WTRU (e.g., using a WTRU ID). Based on this data source ID, the RAN node may send a message to the WTRU, to request the WTRU to send one or more IEs (e.g., measurements) to the RAN node, e.g., over a layer-2 message.

The DCDN publisher information may include one or more data stream parameters, which identify essential characteristics of the data stream, and may help differentiate between different data streams generated by the same source. For example, one or more data stream parameters may include on or more of, e.g., a data type (e.g., a type of IE such as a measurement or event, for example signal strength, energy consumption, radio links related events, packet delays, jitter, and/or location etc.), a precision, a period (e.g., for collecting and/or sending data), a trigger for collecting and/or sending data (e.g., when a measured value changes or reaches a threshold) etc., for example.

The DCDN publisher information may include DCDN authorization information, to determine whether to accept one or more DCDN messages such as one or more subscriptions and/or announcements, including one or more of allowed data stream ID, allowed namespace, user consent information, and/or service threshold information, for example.

The DCDN authorization information may include an allowed data stream ID and/or allowed namespace.

In an example, the allowed data stream ID is used to identify a matching entry in DCDN publisher information. For example, when receiving a subscription including a data stream ID, the DCDN publisher node may select an entry with a matching data stream ID and then may use the data source ID and data stream parameters from this entry, to request the data source to start generating the data stream.

In some systems, for example, one or more allowed data stream IDs are provided and used by the data source and/or data consumer. For example, when receiving a subscription including a data stream ID, the DCDN publisher node may send a request message to the data source identified by a data source ID from a DCDN policy rule with an allowed namespace matching the data stream ID. The request message may include the data stream ID, which the data source uses to accept or reject the request, and to start generating the accepted data stream.

The DCDN authorization information may include user consent information, which indicates that a data stream (e.g., identified by allowed data stream ID and/or allowed namespace) requires user consent. The user consent information may also include a user consent type (e.g., explicit prompt, user configuration) and a privacy level (e.g., low or high anonymization level). It may be appreciated that user consent may be obtained and managed via a dedicated network function (e.g., a user consent management function), and may include information related to the user consent for data collection (e.g., for publishing the user data) and/or user consent for consuming data (e.g., subscribing to user data).

The DCDN authorization information may include service threshold information, which indicates the conditions under which a WTRU publisher may decide to provide, or not, the data stream. Service threshold information may include one or more conditions such as but not limited to WTRU load, network load, publisher priority, subscriber priority, and/or number of subscribers etc., for example. In an example, a WTRU may be configured not to send a data stream if the WTRU (e.g., processing capacity) is overloaded and if there are less than two subscribers, for all data streams that have a low publisher priority. The DCDN publisher node may check one or more service threshold conditions on a continuing basis, during the lifetime of the data streams. For example, the one or more service threshold conditions may be checked whenever a new subscription message is received, and when processing load and network load conditions change. When a subscription is rejected based on service threshold information, the DCDN publisher node may send a subscription pause message, to indicate that the data stream may resume later.

In some systems, for example, all or some data stream publisher or subscriber information may be determined by the application (e.g., WTRU application). In some systems, all or some data stream publisher or subscriber information may be determined by a software component such as a lower layer component of the WTRU or RAN node protocol stack. In an example, the WTRU may forward all data stream IDs from subscriptions within a given namespace, to a WTRU application (e.g., based on a DCDN policy rule including a namespace and an application ID). In another example, the WTRU may forward all data stream IDs listed in a DCDN policy rule, to a WTRU application and/or software component identified in the DCDN policy rule.

In some systems, for example, a data stream ID, data source ID and one or more data stream parameters may be included in a DCDN policy rule to indicate that the DCDN node (e.g., WTRU), when receiving a first subscription for the data stream may request the data source to generate data, using the data stream parameters. The DCDN node may associate the generated data stream with the data stream ID, and send the generated data stream to all peers from which it received a subscription for this data stream ID.

In an example, the one or more DCDN configuration IEs (e.g., a DCDN subscriber IE) may include DCDN subscriber information, which describes how a DCDN subscriber node generates subscription messages.

In an example, the DCDN subscriber information may include DCDN authorization information described hereinbefore, to determine whether to accept DCDN messages such as announcements.

In an example, the DCDN authorization information may include a data consumer ID, which identifies a data consumer (defined hereinbefore). The DCDN node may use the data consumer ID to route received data objects towards the consumer of the corresponding data stream. A data consumer may trigger a data stream subscription.

In an example, the DCDN authorization information may include a data stream ID to subscribe to, and/or an indication that the data consumer will decide which data stream IDs to subscribe to. For example, the DCDN consumer may send a request message to the DCDN subscriber node, including the data stream ID it wishes to receive, and the DCDN subscriber may send a subscription message including this data stream ID, to a peer.

In an example, the DCDN authorization information may include a namespace and one or more data stream parameters, which may enable the DCDN subscriber information to determine a data stream ID to send, based on the type of the one or more data stream parameters that are needed by the data consumer.

In an example, the one or more DCDN configuration IEs (e.g. a DCDN forwarder IE) may include DCDN forwarder information, which describes how a DCDN forwarder handles received subscription and announcements, and how it determines to forward those messages. In an example, the DCDN forwarder information may include DCDN authorization information described hereinbefore, to determine whether to accept one or more DCDN messages such as subscriptions and/or announcements etc.

In an example, the DCDN forwarder information may include one or more default peers, that the DCDN forwarder may forward announcements and/or subscription messages by default.

In an example, the DCDN forwarder information may include one or more non-default peers, that the DCDN forward may accept announcements from. A non-default peer may be associated with one or more namespaces allowed to be announced by this peer.

In an example, the DCDN forwarder information may include one or more non-default peers, that the DCDN forwarder should accept subscription messages from. A non-default peer may be associated with one or more namespaces and this peer is allowed to subscribe data streams within these namespaces.

In an example, the one or more DCDN configuration IEs (e.g., a DCDN communication parameters IE) may include one or more DCDN communication parameters, which identify the properties of the DCDN connection and how data streams are communicated over this connection.

In an example, one or more DCDN communication parameters may include a reliability mode, which may have a value including “reliable” and “unreliable”. For example, when using MOQ as DCDN protocol, the data stream may be transmitted using reliable streams when the reliability mode is “reliable” and using datagrams when the reliability mode is “unreliable”.

In an example, one or more DCDN communication parameters may include N6 QoS information, which may include traffic marking such as a DSCP marking value. For example, in a case where the UPF includes a DCDN NF (e.g., a MOQ relay), the N6 QoS information can be configured in the network by an AF, and may be configured by the network (e.g., SMF) into the UPF, so that the UPF may mark the packets sent over the MOQ connection over N6, e.g., with the DSCP marking value from the N6 QoS information. Here, N6 may refer to the interface that a DCDN NF uses to send data streams to other NFs and data consumers.

In an example, one or more DCDN communication parameters may include a publisher priority, which may be an integer value that is configured (by an AF and/or by the network) in a DCDN node (e.g., WTRU), and that the DCDN node sends in a data stream (e.g., in a publisher priority field in a MOQ datagram or MOQ sub-group header). The publisher priority sent in a data stream can be used by DCDN NFs to influence the scheduling of transmissions of stream data objects.

In an example, one or more DCDN communication parameters may include a subscriber priority, which may be an integer value that is configured (by an AF and/or by the network) in a DCDN node (e.g., WTRU), and that the DCDN node sends in a subscription message. The subscriber priority may be used by one or more DCDN NFs to influence the scheduling of transmissions of stream data objects. The subscriber priority may also be used by the DCDN publisher to determine whether to provide the service or not.

In an example, one or more DCDN communication parameters may include an indication of network responsibility indicative of whether the network is responsible for sending certain messages, while if this indication is not present the WTRU is responsible to send subscription and announcement message. In an example, one or more possible values for this indication include a network subscription value, which indicates that the network is responsible for sending a subscription on behalf of the WTRU, a network announcement value, which indicates that the network is responsible for sending an announcement on behalf of the WTRU, and a combination of those values.

In an example, the one or more DCDN configuration IEs (e.g., a DCDN trigger IE) may include a DCDN trigger (also called “trigger” herein), which identifies a trigger for initiating an action related to DCDN, e.g., initiating a connection to a peer and/or sending an announcement for a namespace and/or subscribing to a DCDN data stream and/or closing a DCDN connection. Examples of one or more DCDN triggers include a type of action associated with the trigger (e.g., sending an announcement or subscription, connecting to a peer). The type of action may in some cases be implicit by association with one or more other DCDN configuration IEs, e.g., in the same DCDN policy rule as the trigger. For example, the value of the DCDN role, and the presence of a namespace, DCDN publisher, subscriber, forwarder information, may be used to derive actions.

Examples of one or more DCDN triggers include a WTRU lifecycle event identifier such as “startup”, “network registration”, “PSA UPF relocation”, “RAN node relocation”, “DCDN connection established”, “DCDN connection lost”. Some other WTRU lifecycle events may be based on location (e.g., enter or leave a given cell or geographical area). The trigger is activated when the WTRU lifecycle event occurs.

Examples of one or more DCDN triggers include a data type (e.g., a type of IE such as a measurement or event, for example a signal strength, an energy consumption, one or more radio links related events, one or more packet delays, jitter, and/or one or more locations etc.), an application type (e.g., sensing application, AI/ML application etc.), and/or an application ID etc. The application ID may be the ID of a third-party application (e.g., a WTRU application), or it may be the ID of a software component on the WTRU (e.g., a software component on a terminal equipment, terminal adaptor or mobile termination portion of a WTRU). The trigger may be activated when an application of this type and/or ID is started and/or when an application and/or software component indicates it consumes or provides data of this type.

Examples of one or more DCDN triggers include a subscribed namespace. The trigger may be activated when an application or software component requests (e.g., through a function call or message) sending a subscription to a data stream ID within this namespace.

Examples of one or more DCDN triggers include an announced namespace. The trigger may be activated when an application or software component requests (e.g., through a function call or message) sending an announcement for this namespace or an included namespace.

In an embodiment, the network configures the WTRU for DCDN. In an aspect, the network may configure the DCDN node (e.g., WTRU) for connecting to the DCDN.

The network (e.g., the PCF through the SMF) may configure one or more DCDN policy rules, including one or more DCDN configuration IEs, on the DCDN node (e.g., WTRU). The one or more DCDN policy rules may include a DCDN trigger that determines when a rule may be activated. The DCDN node may evaluate the one or more DCND policy rules at one or more moments in times corresponding to one or more possible triggers (e.g., when registering with a network and/or when starting a WTRU application).

In some systems, for example, one or more URSP rules may be enhanced to include a DCDN policy rule and/or a reference to a DCDN policy rule. In an example, if a URSP rule is activated when starting a WTRU application, the DCDN policy rule included and/or referenced in an activated URSP rule may indicate that a DCDN connection may be established (and/or an existing DCDN connection may be selected) with one or more characteristics indicated by the DCDN rule, including, e.g., DCDN connectivity information, peer information etc.

In some scenarios, for example, the network (e.g., the SMF) may communicate one or more DCDN configuration IEs to the DCDN node (e.g., the WTRU), in a control plane message such as a PDU session establishment response. In an example, this may be done to provide peer information, which enables the WTRU to connect to the DCDN network through a peer indicated by the provided peer information.

In some scenarios, for example, the network may communicate one or more DCDN configuration IEs to the DCDN node (e.g., the WTRU) in a user plane message, such as an IPV6 router advertisement (RA) including a provisioning domain (PvD) ID FQDN, which the DCDN node uses to retrieve (e.g., over HTTP) PvD information including one or more DCDN information IEs such as peer information, for example.

In an embodiment, the a WTRU may be triggered to connect to a DCDN peer. In an aspect, the DCDN node (e.g., the WTRU) may be triggered to connect to the DCDN.

The DCDN node (e.g., the WTRU) may determine to connect to a peer based on a trigger, e.g., a DCDN trigger defined hereinbefore. For example, the WTRU may register to a mobile network, then evaluate one or more DCDN policy rules, and may determine that a rule is activated, where the rule includes the peer information and one or more other DCDN configuration IEs.

An AF may trigger the establishment of a DCDN connection, by invoking a mobile network API (e.g., through an NEF, a PCF and/or another mobile network NF etc.). The AF may send an API request message to influence an existing SDF, e.g., to enable an AS and the WTRU to exchange data streams through the DCDN network, in relation to this SDF. The AF may send an API request message including a WTRU ID, e.g., to enable the AS and the WTRU to exchange data streams through the DCDN network. The API request message includes one or more DCDN configuration IEs such as a DCDN indication (to indicate that DCDN should be used), DCDN connectivity and/or peer information (to identify how and/or where to connect), the one or more namespaces (e.g., to indicate which one or more namespaces to announce), DCDN role information (e.g., to indicate one or more roles of the WTRU), and one or more other DCDN configuration IEs. The network creates and/or modifies one or more DCDN policy rules, which may be stored as one or more standalone DCDN policy rules and/or included in one or more enhanced PCC rules, e.g., in the PCF. The network may perform an operation such as downloading one or more standalone DCDN policy rules and/or one or more enhanced URSP rules including the one or more DCDN configuration IEs, to the WTRU (e.g., using a configuration update procedure), and/or modifying an existing PDU session based on the one or more DCDN policy rules. When the operation is completed, the network may send a notification to the AF, which may include the one or more DCDN configuration IEs, such as the one or more namespaces and/or data stream ID, e.g., to inform the AF about which namespace and/or data streams are available from the WTRU.

It may be appreciated that the configuration of the one or more DCDN policy rules in the WTRU by the AF (e.g., through the NEF, the PCF and/or another mobile network NF etc.) may apply to the one or more WTRUs (e.g., a group configuration) and that the AF may have performed a member selection step based on group member selection criteria prior to configuring one or more DCDN nodes.

In an embodiment, the WTRU may connect to the DCDN. In an aspect, the DCDN node (e.g., WTRU) may connect to the DCDN. Once a DCDN trigger is activated, the WTRU may establish a DCDN connection to a peer, based on the one or more DCDN configuration IEs such as the DCDN connectivity information and/or the peer information. For example, the trigger may be associated with an action such as sending an announcement, which requires connecting to a peer first. For example, the WTRU may evaluate the one or more DCDN policy rules when a potential trigger occurs (e.g., network registration and/or starting a new WTRU application), and the WTRU activates a DCDN policy rule that matches the potential trigger. The WTRU may then establish a DCDN connection based on the one or more DCDN configuration IEs in the activated DCDN policy rule. Alternatively, in some systems, the WTRU may establish a DCDN connection based on the one or more DCDN configuration IEs which are associated with the DCDN trigger, e.g., which are included in a message from the network (e.g., in a network registration response when the trigger is network registration). If a compatible DCDN connection (e.g., same peer and connectivity information) is already established, the WTRU may reuse it instead of establishing a new one. Otherwise, the WTRU may establish a new DCDN connection.

To establish a new DCDN connection through a RAN, the WTRU may establish a PDU session and/or reuse an existing PDU session to establish the DCDN connection. The parameters for the PDU session including, e.g., the DNN and/or S-NSSAI, may be obtained from the connectivity information of the activated DCDN rule and/or from a URSP rule (e.g., the URSP rule may be selected based on the one or more DCDN configuration IEs from the activated rule, e.g., the peer address, the WTRU application ID and/or a “DCDN application” which represents all DCDN connections). Furthermore, the one or more QoS requirements may be configured in one or more PCC rules and retrieved by the SMF when establishing the PDU session. Once the PDU session is established, the WTRU may establish a DCDN connection with the peer, e.g., the WTRU may establish a MOQ connection with a MOQ relay component on the UPF.

To establish a new DCDN connection over a D2D link, the WTRU (e.g., the first WTRU) may use the D2D information from the activated DCDN rule, e.g., to perform a ProSe discovery procedure, and to establish a D2D connection to a second WTRU. For example, the ProSe application may be a DCDN ProSe application, where the ProSe WTRU application on the first WTRU implements the logic of a DCDN forwarder, and where the ProSe WTRU application on the second WTRU implements the logic of a DCDN subscriber. The first and second WTRU may establish a DCDN connection over the PC5 network interface.

The UPF may include a new DCDN capability indication in (e.g., N4) messages, to inform the network (e.g., the SMF) that it may create a DCDN NF instance. When receiving a PDU session establishment request including a DCDN configuration IE (e.g., a DCDN indication), the SMF may select a UPF with a DCDN capability. The UPF with the DCDN capability may be configured with the address (e.g., a FQDN) of a peer (e.g., a CDN node including a DCDN NF). When creating a DCDN NF instance (e.g., a MOQ relay instance), the UPF may provide the configured peer address to the created DCDN NF instance, and the created DCDN NF instance may connect to the configured peer, that it may use as a default destination for one or more future announcements and/or subscription messages, for example.

One or more announcements and/or subscription messages corresponding to different applications (e.g., to different DCDN policy rules) may be transmitted over a single DCDN connection or over multiple DCDN connections. In an example, within a same DCDN connection, a WTRU may send one or more announcements for different namespaces (possibly corresponding to different data sources), and send one or more subscriptions for different data stream IDs, with some of these announcements and/or subscriptions initiated from the WTRU and possibly some of them forwarded from other peers (e.g., other WTRUs). Within the same DCDN connection, different data streams may use different DCDN communication parameters (e.g., a data stream over datagrams, another over a reliable stream, using different DSCP marking over N6, and/or different priorities etc.). In an example, different DCDN policy rules that are compatible (e.g., same peer information and DCDN connectivity information) may enable announcements, subscriptions, and/or data to be transmitted over a single DCDN connection to a peer, over a single PDU session. In an example, different DCDN policy rules that have the same DCDN connectivity information, but different peer information can enable announcements, subscriptions, data to be transmitted to different peers over the same PDU session and possibly over the same QoS flow. In an example, different DCDN policy rules that have the same peer information, but different DCDN connectivity information may enable announcements, subscriptions, data to be transmitted over different DCDN connections to the same peer, which are established over different PDU sessions and/or different QoS flows within a PDU session.

In an embodiment, the WTRU may be and/or act as a DCDN publisher node. An embodiment provides how a DCDN node (e.g., WTRU) collocated with a data source may act as a DCDN publisher node.

Once connected to a peer, a DCDN publisher node (e.g., a WTRU) may send, to the peer, an announcement message including a namespace, e.g., a MOQ ANNOUNCE message, to indicate that it will accept one or more subscriptions within this namespace. In some cases, the DCDN node (e.g., the WTRU) may obtain the namespace from one or more DCDN configuration IEs, e.g., from a DCDN policy rule activated based on a trigger. In some cases, the DCDN node may generate the namespace using an algorithm, e.g., based on a WTRU ID, network ID and a namespace fragment, where the namespace fragment may be obtained from the DCDN configuration and/or may be derived from one or more other IEs (e.g., from an application ID). In some cases, the DCDN node may announce a namespace based on a request from an application or software component (e.g., a WTRU application), which includes a namespace and/or a namespace fragment.

When connected to multiple peers, the DCDN publisher node may determine the one or more destination peers of the announcement message, based on the one or more DCDN configuration IEs, e.g., from the activated DCDN policy rule. In an example, if a default destination indicator is present in the peer information, the peer associated with the default destination indicator may be selected. If the DCDN publisher node is connected to multiple default destination peers, the node may select one based on an algorithm (e.g., at random). If the DCDN publisher node received a subscription for announcements (e.g., a MOQ SUBSCRIBE_ANNOUNCES message), and if the namespace to announce matches (e.g., is inside) the namespace in the subscription, then the DCDN publisher node may send an announcement message to the peer which originated the subscription.

The DCDN publisher node may receive a subscription message including a data stream ID. The DCDN publisher node selects a matching entry in the DCDN publisher information. An entry may match if the received data stream ID equals the allowed data stream ID and/or is within the allowed namespace. If there are multiple matches, the entry with the exact data stream ID may be selected, if any, and otherwise the entry with the longest namespace may be selected. The DCDN publisher node may determine how to process the subscription message based on the one or more IEs in the selected DCDN publisher information entry.

In an example, the DCDN publisher node may determine if the received data stream ID is valid, in some cases, for example, with the support of the data source (identified by the data source ID in the selected entry). If the data stream ID is invalid, the subscription is rejected, e.g., the DCDN publisher node sends a subscription failed message to the peer which originated the subscription.

In an example, the DCDN publisher node determines, using user consent information, if the user consented to the data stream ID, otherwise the subscription is rejected.

In an example, the DCDN publisher node determines, using service threshold information, if the conditions are met to provide the data stream to the subscriber, otherwise the subscription may be paused or rejected.

In an example, if the subscription is not rejected or paused, and if there are no current non-paused subscriptions for the data stream, the DCDN publisher node may request the data source, e.g., using a function call or a message, to generate the data stream. In an example, the request may include the data stream ID and/or a data stream ID suffix and data stream parameters. The data source may reply with a success code. If the data stream was successfully generated, the DCDN publisher node may send a subscription response message (e.g., in MOQ, a SUBSCRIBE_OK message) to the peer which sent the subscription message. When the last subscription ends for a data stream, e.g., when receiving a subscription cancellation message (e.g., a MOQ UNSUBSCRIBE message), the DCDN publisher node requests the data source to stop generating the data objects for this stream.

In an example, the DCDN publisher node may listen to one or more data objects emitted by the data source, and may forward the received data objects towards all peers which have at least one active subscription for the data stream ID.

In some systems, for example, a network node (e.g., the PCF, the SMF, the UPF and/or a data plane NF etc.) may announce one or more namespaces on behalf of the DCDN publisher node (e.g., the WTRU). A DCDN policy rule may include an indication of network responsibility, which indicates that some messages (e.g., one or more announcements) may be sent by the network, on behalf of the DCDN node. In an example, based on the DCDN policy rule, the SMF may configure the UPF to send an announcement message for a namespace on behalf of the WTRU. In this case, based on the indication of network responsibility in the one or more DCDN information IEs obtained from the network, the WTRU does not send the announcement message, and configures itself to receive subscription messages for data stream IDs within the namespace.

In an example, in a scenario where the RAN node is a DCDN node publisher, the RAN node receives a configuration (e.g., from a CN node or an OAM etc.) including the DCDN connection information (e.g., an interface to use to connect to an IP network to use for DCDN traffic) and the DCDN peer information (e.g., the FQDN of a DCDN NF). The RAN node may connect to the DCDN peer. The RAN node may then send and/or receive one or more announcements, subscriptions and data objects to/from the DCDN peer.

In an embodiment, the WTRU may be and/or act as a DCDN subscriber node. In an aspect, a DCDN node (e.g., a WTRU) may act as a DCDN consumer.

The DCDN consumer node (e.g., the WTRU) may send one or more subscription messages to a peer, including a data stream ID. In an example, the subscription message may be a MOQ SUBSCRIBE message. In some cases, the WTRU may obtain the data stream ID from a DCDN policy rule (e.g., when activating a rule based on a trigger). In some cases, the WTRU may obtain the data stream ID from an application or software component, which may request a data stream from the WTRU (e.g., using a function call or message).

When connected to multiple peers, the DCDN subscriber node may determine the destination peer of the subscription message, based on one or more DCDN configuration IEs and/or on one or more previously received announcements. If the DCDN subscriber node previously received, from a peer, an announcement for a namespace that matches (e.g., includes) the data stream ID, the DCDN subscriber node may send the subscription message to this peer. If the DCDN subscriber node previously received multiple matching announcements, the DCDN subscriber nodes may send the subscription message to the peer it receives the longest matching namespace announcement from. If the DCDN subscriber node did not previously receive an announcement with a matching namespace, the DCDN subscriber node may send the subscription message to a default destination peer, based on the one or more DCDN configuration IEs.

In some systems, for example, the network (e.g., the PCF, the SMF, the UPF and/or data plane NF etc.) may subscribe on behalf of the DCDN subscriber node (e.g., the WTRU). A DCDN policy rule may include an indication of network responsibility, which indicates that some messages (e.g., subscriptions) may be sent by the network, on behalf of the DCDN node. In an example, based on the DCDN policy rule, the SMF may configure the UPF to send a subscription message for a data stream ID on behalf of the WTRU. In this case, based on the indication of network responsibility in the one or more DCDN information IEs obtained from the network, the WTRU does not send the subscription message, and configures itself to receive one or more data objects for the data stream ID.

In an embodiment, the WTRU may be and/or act as a DCDN forwarder node. In an aspect, a DCDN node (e.g., a WTRU) may act as a DCDN forwarder (e.g., between another WTRU and the DCDN network).

The DCDN forwarder node is configured to connect to two or more DCDN nodes and may send and receive one or more announcement and/or subscription messages. In an example, the DCDN forwarder node may be configured to connect to a UPF DCDN NF peer over a PDU session, and to a second WTRU peer over a D2D link.

When receiving an announcement message from a peer, the DCDN node (e.g., a subscriber and/or a forwarder etc.) determines whether it accepts the message, e.g., it may look up one or more DCDN policy rules for triggers that match the namespace and use DCDN authorization information from the rule to determine whether to accept the message. If the DCDN node is a subscriber and/or forwarder, accepting an announcement message may include storing the tuple (namespace, peer) to determine the destination peer when sending a subscription message. If the DCDN node is a forwarder, accepting an announcement message may additionally include forwarding the announcement message.

When receiving a subscription for a data stream ID and/or for one or more namespace announcements from a peer, a DCDN node (e.g., publisher or forwarder) determines whether it accepts the message, e.g., it can look up one or more DCDN policy rules for one or more triggers that match the data stream ID and/or namespace and use DCDN authorization information from the rule to determine whether to accept the message. If the DCDN node is a publisher and/or forwarder, accepting a data stream subscription message may include storing the tuple (data stream ID, peer) to determine the destination peer when sending a data object. If the DCDN node is a publisher and/or forwarder, accepting a namespace announcement subscription message may include storing the tuple (namespace, peer) to determine the destination peer when sending an announcement. If the DCDN node is a forwarder, accepting a subscription message may additionally include forwarding the subscription message.

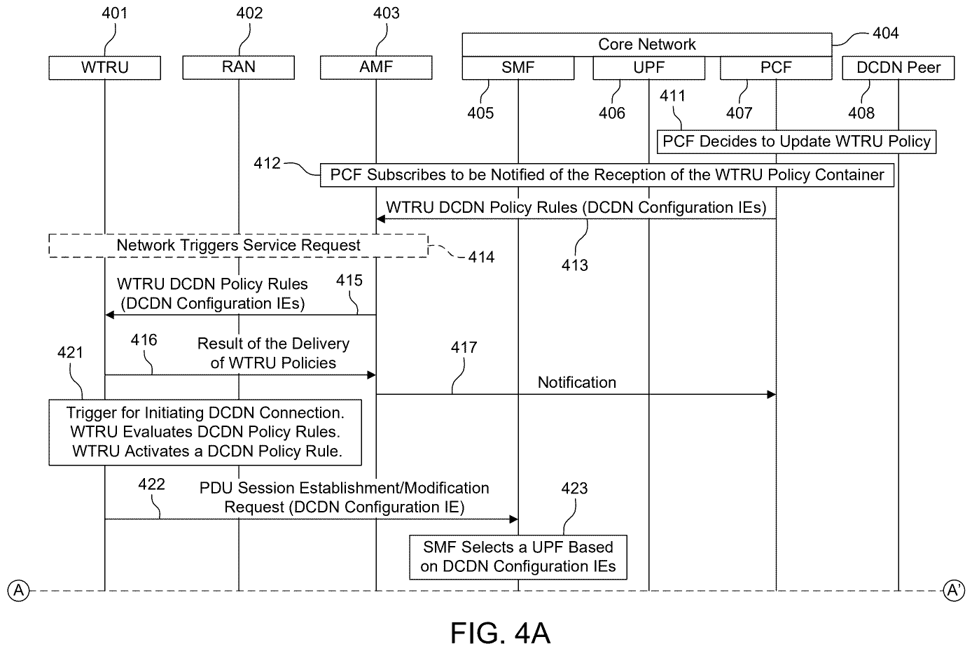

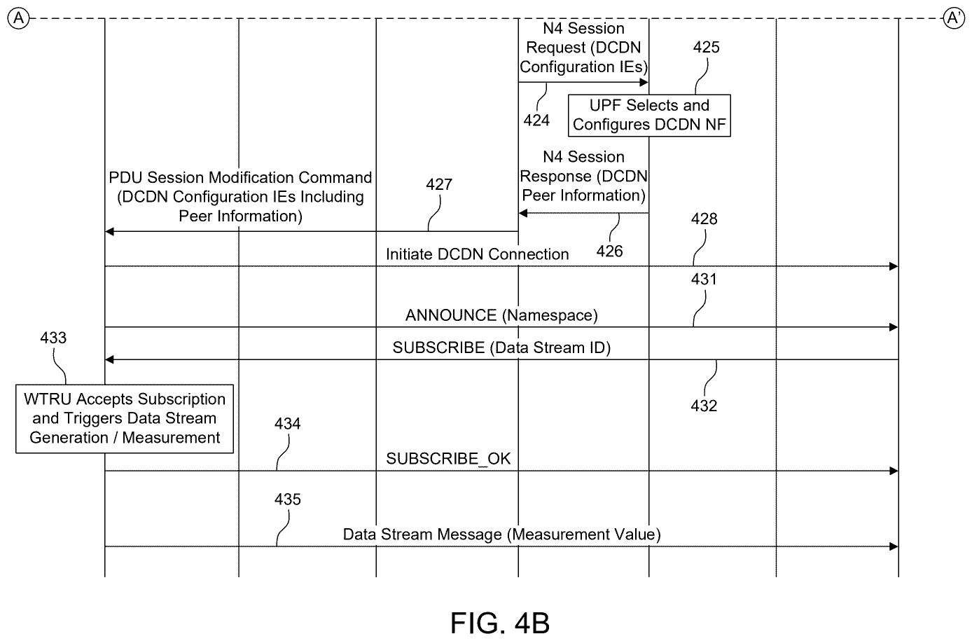

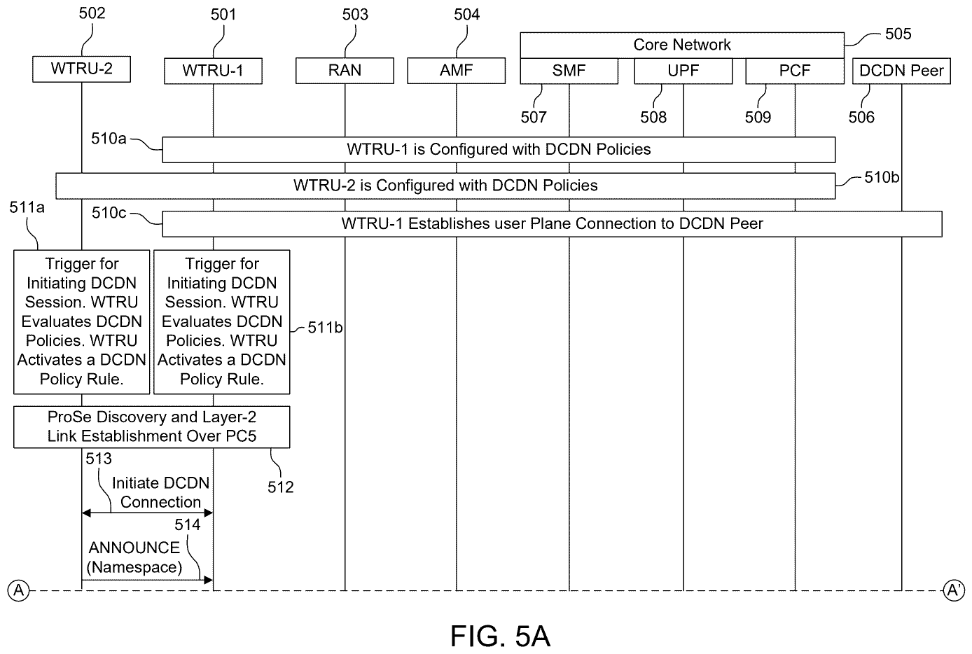

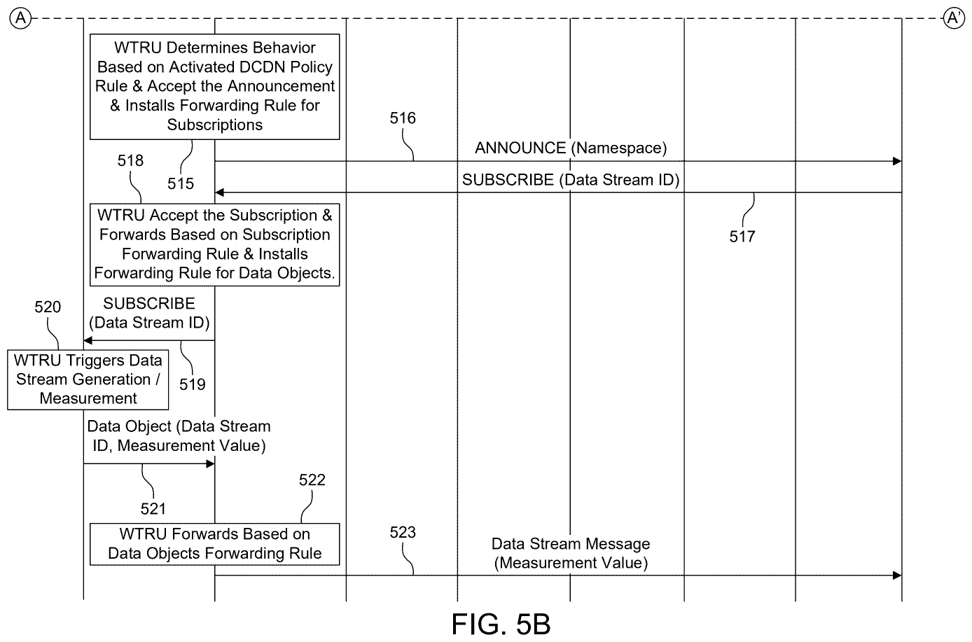

FIGS. 4-5 illustrate one or more DCDN procedures involving a WTRU. FIGS. 4-5 illustrate one or more user plane messages such as one or more SUBSCRIBE messages and/or ANNOUNCE messages and does not show some messages such as one or more ANNOUNCE_OK messages (which is a positive response to an ANNOUNCE message) and one or more SUBSCRIBE_ANNOUNCE messages (which may be used to request announcements within a namespace).

In an embodiment, a WTRU may publish one or more measurements.

Referring now to Error! Reference source not found., an example flow diagram where a WTRU publishes and sends one or more measurements through a DCDN network is shown according to one or more embodiments. The flow diagram illustrates a WTRU 401, a RAN 402, an AMF 403, a core network 404, and a DCDN peer 408. The core network 404 includes an SMF 405, a UPF 406, and a PCF 407.

In FIGS. 4A-4B, 411-417 represent the configuration of one or more DCDN policy rules on the WTRU, e.g., based on a NAS procedure (e.g. the WTRU configuration update procedure).

At 411, the PCF 407 may decide to update a WTRU policy for a DCDN and send the WTRU policy for the DCDN to the WTRU 401. For example, this may happen when the network operator provisions one or more new DCDN policy rules in the network, to configure a DCDN service for the WTRU. In another example, this may happen when the AF sends an API request message including one or more DCDN configuration IEs to the PCF 407 (or to the NEF which provide the one or more DCDN configuration IEs to the PCF 407), to request a DCDN service for the WTRU 401. The DCDN service may be, e.g., for the WTRU 401 to establish a DCDN connection to the DCDN peer 408, which is then available for applications and software components on the WTRU 401, to announce namespaces, transmit and/or receive data streams etc. The PCF 407 may decide to send a WTRU policy for DCDN to the WTRU 401 when the PCF 407 detects that the WTRU 401 performs an initial registration procedure and/or when the PCF 407 detects that the WTRU 401 has registered with a different PLMN.

At 412, the PCF 407 may subscribe to be notified of the reception of the WTRU 401 policy container.

At 413, the PCF 407 may transmit the one or more WTRU DCDN policy rules to the AMF 403, including the one or more DCDN configuration IEs. This message may include a NAS container. The NAS container may include the one or more WTRU DCDN policy rules.

At 414, the network may trigger a service request (e.g., it may page the WTRU 401).

At 415, the AMF 403 may transmit the one or more WTRU DCDN policy rules including the one or more DCDN configuration IEs. In an example, the AMF 403 may send the NAS container including the one or more WTRU DCDN policy rules that was received from the PCF to the WTRU 401. Upon receiving the one or more DCDN policy rules, the WTRU 401 stores them in its internal state. From this point on, the WTRU 401 evaluates the one or more DCDN policy rules when receiving a potential trigger (e.g., when registering with the network, when starting a new WTRU application, when receiving one or more DCDN subscriptions and announcement message).

At 416, the WTRU 401 may send, to the AMF 403, a message including the result of the delivery of the one or more WTRU policies.

At 417, the AMF 403 may notify the PCF 407 of the result of the delivery of the WTRU policies.

411-417 show an example of how a NAS procedure is used to send the WTRU DCDN policy to the WTRU 401 via the AMF 403 and signaling radio bearers. It should be appreciated that other procedures may be used to send the WTRU DCDN policy to the WTRU 401. For example, a PDU session may be used to communicate the WTRU DCDN policy from the PCF 407 to the WTRU 401. Additionally, a different type of radio bearer may be used to communicate the WTRU DCDN policy from the PCF 407 to the WTRU 401. For example, the radio bearer may be a data radio bearer and/or a radio bearer that is used for data plane messaging.

421-428 of FIGS. 4A-4B illustrate an establishment and/or modification of a PDU session to establish a DCDN connection. In some cases, for example, where the DCDN peer information indicates a D2D link, 421-428 may be replaced by the WTRU 401 discovering and connecting to a second WTRU 401, over a D2D link.

At 421, the WTRU 401 may receive a DCDN trigger, e.g., it registers with the network and/or starts a new WTRU application. The WTRU 401 may evaluate the one or more DCDN policy rules against the trigger and activate a DCDN policy rule that matches the trigger. Based on the activated DCDN policy rule, the WTRU 401 determines it needs to initiate a DCDN connection. In this example procedure, the activated DCDN policy rule indicates to connect to a peer and act as a publisher corresponding to a namespace and a data source. For example, the DCDN policy rule may include one or more of the DCDN connectivity information, the peer information, the namespace, the role information (including “publisher”), the publisher information, one or more communication parameters, and a trigger etc. It may be appreciated that the activation of a DCDN policy rule may be subject to user consent and that user consent may be pre-configured on the WTRU 401 or may be obtained dynamically by requesting the user to consent to the DCDN policy rule activation.

At 422, the WTRU 401 may send a PDU session establishment and/or modification request message, including one or more DCDN configuration IEs, e.g., including a DCDN indication.

At 423, the SMF 405 may select the UPF 406 which supports the DCDN, based on the one or more DCDN configuration IEs from the message of 422, and/or from an enhanced PCC rule.

At 424, the SMF may send an N4 session request message to the UPF 406, including the one or more DCDN configuration IEs such as a DCDN indication and one or more DCDN communication parameters.

At 425, the UPF 406 may select and configure a DCDN NF instance (e.g., a MOQ proxy) using the one or more DCDN configuration IEs (e.g., the UPF 406 may create an instance and select it, or the UPF 406 may select an existing instance that corresponds to the same DCDN configuration IEs). For example, in some cases the UPF 406 may use DCDN communication parameters to configure the DCDN NF to mark N6 traffic with N6 QoS information, and/or to send subscriptions and/or announcements to the DCDN network on behalf of the WTRU 401. In some cases, the UPF 406 may use DCDN forwarder information to determine how to handle the one or more subscriptions and announcements. In some cases, the UPF 406 may use the DCDN peer information to determine through which peer to connect to the DCDN network.

At 426, the UPF 406 may send a N4 session response message to the SMF 405, which may include DCDN peer information, that describe the DCDN NF for the WTRU 401 to establish a DCDN connection with.

At 427, the SMF 405 may send to the WTRU 401 a PDU session establishment and/or modification command, including the one or more DCDN configuration IEs. The message may include DCDN peer information from the UPF 406. In some cases, the message may include a namespace that the WTRU 401 may announce, or a namespace fragment that the WTRU 401 may use to create the one or more namespaces for different applications. The message may include a DCDN role information, and DCDN publisher, subscriber, and/or forwarder information, one or more DCDN communication parameters, and one or more DCDN triggers, that the WTRU 401 may use to configure itself with, to provide a DCDN service.

At 428, the WTRU 401 may determine a peer (e.g., internet protocol (IP) address) based on peer information, and may initiate a user plane connection with the peer, using the DCDN protocol (e.g., MOQ or MQTT). It may be appreciated that the initiation of the DCDN connection may be subject to a user consent determined in 421 and that user consent may alternatively or additionally be determined and/or re-determined in 428.

431-435 of FIGS. 4A-4B illustrate the operation of the DCDN connection by the WTRU 401 acting as a DCDN publisher node.

At 431, the WTRU 401 may send to the peer an announcement message (e.g., MOQ ANNOUNCE message) including a namespace, where the namespace is obtained, e.g., from a DCDN policy rule, from the activated DCDN policy rule, from the one or more DCDN configuration IEs in the 427 message, from a data source, or from a WTRU application and/or software component. The DCDN peer 408 may propagate the announcement within the DCDN network, which is not shown. The DCDN peer 408 may send a response to the WTRU 401 (e.g., a MOQ ANNOUNCE_OK), which is not shown. It can be appreciated that sending the announcement message may be subject to a user consent determined in 421 and that user consent may alternatively or additionally be determined and/or redetermined in step 431.

At 432, the DCDN peer 408 may send to the WTRU 401 a subscription message (e.g., MOQ SUBSCRIBE message) including a data stream ID. The received data stream ID is within the announced namespace.

At 433, the WTRU 401 may select a set of DCDN configuration IEs, e.g., based on information from the network in message 427, or from a DCDN policy rule including the longest namespace that includes the received data stream ID. Based on the selected set of DCDN configuration IEs, the WTRU 401 may determine the subscription is acceptable, which may include nut is not limited to checking for the DCDN authorization information such as allowed namespace, allowed data stream IDs, user consent information and checking for a service threshold information (as described herein). It may be appreciated that accepting the subscription may be subject to validating if the user is consenting to the one or more subscribers consuming the published data. It may further be appreciated that the DCDN configuration IE provided in 423 may include one or more identifiers of the one or more subscribers that the user consented to. The DCDN network may use the user consented subscriber list to allow the delivery of the subscription message 432 to the WTRU. In an example, a user consented subscriber list may have been provided to the DCDN network in 422 and the DCDN network may only deliver the subscription from peers in the user consented subscriber list. Based on the set of DCDN configuration IEs, the WTRU 401 identifies the data source. The WTRU 401 may transmit a request message to the data source, including the one or more DCDN configuration IEs such as data stream parameters. Upon reception of the request, the data source may verify the validity of the data stream ID (e.g., whether the data stream ID is known to the data source) and starts generating the data stream.

At 434, the WTRU 401 may send to the peer a response message (e.g., a MOQ SUBSCRIBE_OK), to indicate that the subscription was accepted. In some cases, the WTRU 401 may send a different response message (e.g., a new message SUBSCRIBE_PAUSED) to indicate that the subscription was not accepted because it did not reach a service threshold, but may be accepted in the future (e.g., when more subscriptions are received for the same data stream). The one or more DCDN NFs may process a SUBSCRIBE_PAUSED message in a manner similar to a SUBSCRIBE_OK to update the forwarding tables for data objects. A DCDN subscriber node receiving a SUBSCRIBE_PAUSE may decide to wait for the data stream to start, or it may decide to cancel the subscription.

At 435, the data source may emit a data object in the data stream, where the data object includes an IE such as a measurement or event, whose generation was started by the WTRU 401 based on a subscription, e.g., in 433. For example, the data source may generate one or more of IEs, measurements and/or events, such as a signal strength, an energy consumption, one or more radio links related events, one or more packet delays, jitter, and/or one or more locations etc. The WTRU 401 may transmit the data object to the peer (and to all other peers that may have sent a subscription for this data stream).

While the scenario from FIGS. 4A-4B represents the WTRU 401 as DCDN publisher, other scenarios may be derived from it, where the DCDN publisher is another, e.g., a RAN node. In an example scenario, an NF may use the one or more measurements from the WTRU 401, obtained through a connection through a RAN node, for providing a service to improve the QoE and/or to train an AI/ML model. The measurements from the WTRU 401 include one or more RAN-visible IEs such as but not limited to one or more channel quality measurements and one or more non-RAN-visible IEs such as but not limited to a codec feedback on the QoE. As part of the service provided by the NF, the RAN node may use the one or more RAN-visible IEs to adapt the WTRU connection to the RAN node, e.g., the RAN node can use channel quality measurement IEs and other measurements, to adjust the link to improve the QoE by increasing signal quality.

In an embodiment, the NF may subscribe to a data stream “Z”, corresponding to the one or more WTRU measurements, and published by the RAN node. Upon receiving the subscription message for “Z”, the RAN node sends a message to the WTRU, requesting the WTRU to generate and send to the RAN, e.g., in layer-2 messages, the one or more WTRU measurements including the one or more RAN-visible and non-RAN-visible IEs. The RAN uses the one or more RAN-visible IEs to adapt the WTRU connection to the RAN node. The RAN sends one or more data objects, including the one or more WTRU measurements, to the data stream “Z” subscribers, including the NF, through a DCDN peer.

In an embodiment, the NF may subscribe to 2 data stream IDs, including one data stream “A” of the one or more RAN-visible IEs, and one data stream “B” of the one or more non-RAN-visible IEs. The data stream “A” is published by the RAN node 402. The data stream “B” is published by the WTRU 401. Upon receiving the subscription message for “A”, the RAN node 402 sends a message to the WTRU 401, requesting the WTRU 401 to generate and send to the RAN node 402, e.g., in one or more layer-2 messages, the one or more WTRU measurements including the one or more RAN-visible IEs. The RAN node 402 may use the one or more RAN-visible IEs to adapt the WTRU connection to the RAN node 402. The RAN node 402 may send the one or more data objects including the one or more RAN-visible IEs to the data stream “A” subscribers, including the NF, through a DCDN peer. Upon receiving the subscription message for “B”, the WTRU 401 may initiate the generation of the one or more non-RAN-visible IEs measurements and transmit them to the data stream “B” subscribers, including the NF, through a DCDN peer over the user plane.

In an embodiment, the NF subscribes to 2 data stream IDs, including one data stream “A” of the one or more RAN-visible IEs, and one data stream “B” of the one or more non-RAN-visible IEs. In an example, the RAN, instead of obtaining the one or more data objects from the WTRU 401 over the one or more layer-2 messages, subscribes to a data stream “C” of the one or more RAN-visible IEs published by the WTRU 401 (and transmitted by the WTRU 401 over the user plane through the DCDN network).

In an embodiment, the NF subscribes to the 2 data stream IDs “A” and “C” described hereinbefore, both published by the WTRU 401. Furthermore, the NF sends a message to the RAN node 402, requesting the RAN node 402 to adapt the WTRU connection to the RAN node 402 using the one or more RAN-visible IEs. The RAN node 402, upon receiving the message, subscribes to the data stream “C”, and uses the one or more RAN-visible IEs from the data objects of stream “C” to adapt the connection.

Various embodiments assist with various AI/ML functions like training using a combination of the one or more RAN visible IEs and proprietary AI/ML reporting for training and/or monitoring and may also apply to other data reporting. In an embodiment, a WTRU forwards one or more measurements.

Error! Reference source not found. A-5B, an example flow diagram of a method where a WTRU acts as a DCDN forwarder between a WTRU and the DCDN network is illustrated according to one or more embodiments. FIGS. 5A-5B illustrate a first WTRU (WTRU-1) 501, a second WTRU (WTRU-2) 502, a RAN node 503, an AMF 504, a core network 505, and a DCDN peer 506. The core network 505 comprises an SMF 507, a UPF 508, and a PCF 509.

At 510a, the WTRU-1 501 is configured with one or more DCDN policy rules, such as described in FIGS. 4A-4B.

At 510b, the WTRU-2 502 is configured with the one or more DCDN policy rules, such as described in FIGS. 4A-4B.

At 510c, the WTRU-1 501 establishes a user plane connection to a peer, as described in FIGS. 4A-4B.

511-523 of FIGS. 5A-5B illustrate the WTRU-1 501 forwarding one or more announcements and/or subscription messages between the second WTRU-2 502 and the DCDN peer 506 in the network.

At 511 and 511b, the WTRU-1 501 and/or the WTRU-2 502 may receive a trigger for initiating a DCDN connection. The WTRU-1 501 and/or the WTRU-2 502 may evaluate the one or roe DCDN policies and activate a DCDN policy rule matching the trigger. In this example procedure, the activated DCDN policy rule indicates to connect to act as a forwarder. For example, the DCDN policy rule may include one or more of DCDN connectivity information, peer information, namespace, role information (including “forwarder”), forwarder information, communication parameters, and/or trigger etc.

At 512, the WTRU-1 501 and the WTRU-2 502 may perform a D2D discovery and/or establish a D2D link, e.g., over PC5.

At 513, the WTRU-1 501 or WTRU-2 502 may initiate the DCDN connection with the other WTRU peer. For example, a DCDN Prose application on the WTRU-1 may initiate a MOQ connection to a DCDN Prose application on the WTRU-2 502.

At 514, the WTRU-2 502 may send an announcement message to the WTRU-1, including a namespace.

At 515, the WTRU-1 501 may determine its behavior based on one or more DCDN policy rules. The WTRU-1 501 may determine to accept the announcement message based on the DCDN authorization information, which may include checking if the namespace is allowed, checking for user consent information and checking for a service threshold information (as described herein). The WTRU-1 501 may determine to forward the announcement based on the DCDN role information, e.g., if the DCDN role information includes the forwarder role. The WTRU-1 501 installs a forwarding rule for one or more subscriptions within the namespace. The WTRU-1 determines which peer to forward the message to, as described herein.

At 516, the WTRU-1 501 may send an announcement message to the peer, including the namespace.

At 517, the WTRU-1 501 may receive, from the peer, a subscription message including a data stream ID.

At 518, the WTRU-1 501 may determine to accept the subscription message based on the DCDN authorization information, which may include checking if the data stream ID is allowed (e.g., if it is inside an allowed namespace), checking for user consent information and checking for a service threshold information (as described herein). The WTRU-1 may determine to forward the subscription based on the DCDN role information, e.g., if the DCDN role information includes the forwarder role. The WTRU-1 501 may install a forwarding rule for one or more future data objects within the data stream. The WTRU1 may forwards the subscription towards the WTRU-2 502 peer, as determined by the forwarding rule for subscriptions.

At 519, the WTRU-1 501 may send a subscription message to the WTRU-2 502 peer, including the data stream ID.

At 520, the WTRU-2 502 may trigger the data stream generation (e.g., a measurement) from the data source corresponding to the data stream ID, if needed.

At 521, the data source generates a data object for the subscribed stream. The WTRU-2 502 may send, to the WTRU-1 501, the data object, including a measurement value and the data stream ID or a reference to the data stream ID.

At 522, the WTRU-1 501 forwards the data object based on the forwarding rule for data objects.

At 523, the WTRU-1 501 sends the data object to the peer.

It may be appreciated that steps 511a, 513, 514, 519 and 520 may be subject to user consent as described in FIGS. 4A-4B.

In an embodiment, the WTRU may subscribe to one or more model updates

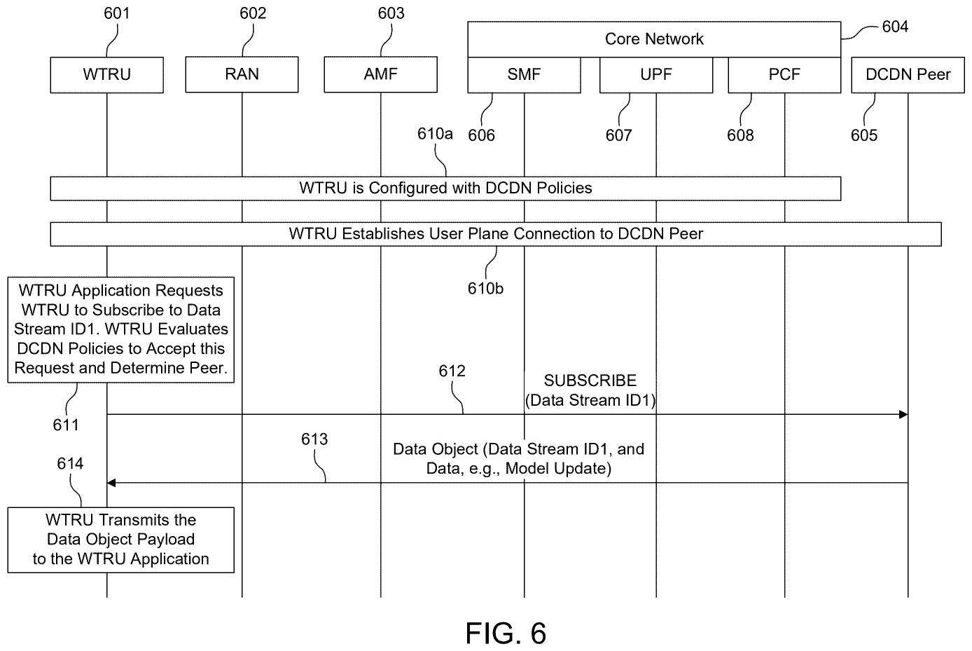

Referring now to FIG. 6, a flow diagram of an example procedure where a WTRU subscribes and receives model updates from a DCDN network is shown according to one or more embodiments. FIG. 6 illustrates a WTRU 601, a RAN 602, an AMF 603, a core network 604, and a DCDN peer 605. The core network 604 includes an SMF 606, a UPF 607, and a PCF 608.

The WTRU 601 may connect to a DCDN network and subscribe to a data stream, e.g., one or more model updates for an AI/ML application. In some systems, multiple WTRUs may use a procedure based on FIG. 6, to each receive the one or more AI model updates that are published by a AS and/or NF, and some WTRUs may subscribe to the one or more AI model updates through other WTRUs over D2D links.

At 610a, the WTRU 601 is configured with one or more DCDN policy rules, such as described in FIGS. 4A-4B.

At 610b, the WTRU 601 establishes a user plane connection to a peer, as described in FIGS. 4A-4B.

611-614 of FIG. 6 represents the WTRU 601 subscribing to a data stream ID (e.g., to receive a stream of model updates).

At 611, the WTRU 601 may receive a trigger, e.g., an application request (e.g., a message and/or a function call from a local WTRU application) for subscribing to a data stream ID1. The WTRU 601 may evaluate the one or more DCDN policies and activate a DCDN policy rule matching the trigger. In this example, the activated DCDN policy rule indicates to connect to a peer and act as a subscriber for a data consumer. For example, the DCDN policy rule may include one or more of DCDN connectivity information, peer information, role information (including “subscriber”), subscriber information, communication parameters, and trigger.

The WTRU 601 may determine to accept sending the subscription message based on the DCDN authorization information, which may include checking if the data stream ID is allowed (e.g., if it is inside an allowed namespace), checking for user consent information and checking for a service threshold information (as described herein). The WTRU may determine the peer to use for sending the subscription message, as described herein.

At 612, the WTRU 601 may send a subscription message to the peer, including the data stream ID1.

At 613, the WTRU 601 may receive, from the peer, a data object including the data stream ID1 or a reference to the data stream ID1 and, e.g., a module update.

At 614, the WTRU 601 may transmit the data object payload to the WTRU application.

It may be appreciated that the DCDN network may reject the subscription in 612 based on the user consented subscriber list as described in FIGS. 4A-4B.

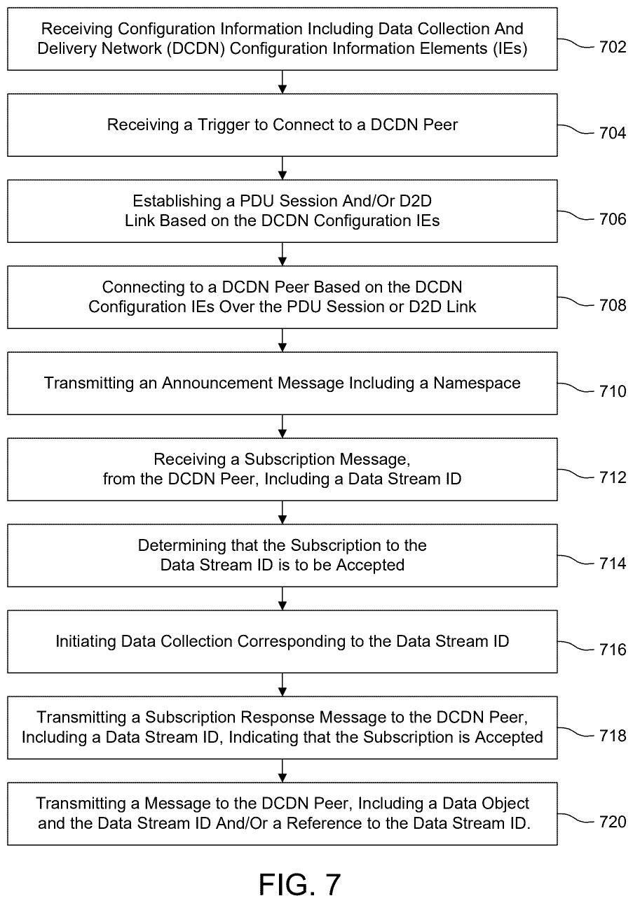

Referring now to FIG. 7, a flowchart illustrating an example method of enabling low-latency data collection and delivery is shown according to one or more embodiments. The method may be performed by a WTRU and/or a RAN node.

At 702, the WTRU may receive configuration information including one or more DCDN configuration IEs, e.g., including, but not limited to, one or more of: a DCDN indication IE, a DCDN connectivity IE, a DCDN peer IE, a DCDN namespace IE, a DCDN role IE, a DCDN publisher IE, a DCDN subscriber IE, a DCDN forwarder IE, a DCDN communication parameters IE, and/or a DCDN trigger IE etc. In an example, the one or more DCDN configuration IEs may be included in a CP (e.g., NAS) message and/or a UP message and/or a DCDN policy rule. The WTRU may also receive a DCDN indication to collect and send data through the DCDN.

At 704, the WTRU may receive a trigger to connect to a DCDN peer. In an example, the trigger may be a message from 702 and/or a different DCDN trigger, such as, but not limited to, a network registration, a WTRU relocation event, running a WTRU application, etc. In an example, the trigger may also include receiving a request to announce a namespace, e.g., from a WTRU application, a software component, or from the network.

At 706, the WTRU may establish a PDU session and/or a D2D link based on the DCDN configuration IEs, e.g., based on DCDN connectivity information. The WTRU may connect to the DCDN peer using the PDU session and/or the D2D link.

At 708, the WTRU may connect to the DCDN peer based on the one or more DCDN configuration IEs, e.g., based on DCDN peer information, using the PDU session and/or the D2D link.

At 710, the WTRU may transmit an announcement message including the namespace. In an example, the namespace may be explicit in the one or more DCDN configuration IEs and/or may be provided by a WTRU application and/or a software component.

At 712, the WTRU may receive a subscription message, from the DCDN peer, including a data stream ID.

At 714, the WTRU may determine that the subscription to the data stream ID is to be accepted. In an example, the WTRU may check whether the data stream ID corresponds to a valid data stream, whether the data stream ID is consented by a user, whether the data stream ID matches a service threshold, and/or the like.

At 716, the WTRU may initiate data collection corresponding to the data stream ID.

At 718, the WTRU may transmit a subscription response message to the DCDN peer, including a data stream ID, indicating that the subscription is accepted.

At 720, the WTRU may transmit a message to the DCDN peer, including a data object and the data stream ID and/or a reference to the data stream ID.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A method performed by a wireless transmit/receive unit (WTRU), the method comprising:
receiving configuration information including one or more data collection and delivery network (DCDN) configuration information elements (IEs);
establishing, based on the one or more DCDN configuration IEs, a DCDN connection with a DCDN peer;
transmitting, based on the one or more DCDN configuration IEs, an announcement message including a namespace;
receiving, from the DCDN peer, a subscription message including a data stream identifier (ID);
collecting, based on the subscription message, one or more data objects corresponding to the data stream ID; and
transmitting, to the DCDN peer, a message determined based on the one or more data objects, over the DCDN connection.

2. The method of claim 1, wherein the one or more DCDN configuration IEs are received using one or more of:
a control plane (CP) message,
a user plane (UP) message, or
a DCDN policy rule.

3. The method of claim 1, further comprising:
receiving a trigger for establishing a connection with the DCDN peer,
wherein the DCDN connection is established based at least on the trigger.

4. The method of claim 3, wherein the one or more DCDN configuration IEs include at least one of:
a DCDN connectivity IE indicative of DCDN connectivity information,
a DCDN peer IE indicative of DCDN per information, or
a DCDN trigger IE indicative of the trigger.

5. The method of claim 1, further comprising:
determining that the subscription message is acceptable; and
transmitting, to the DCDN peer, a subscription response including the data stream ID indicating that the subscription message is accepted.

6. The method of claim 5, wherein determining that the subscription message is acceptable comprises one or more of:
determining that the data stream ID indicated by the subscription message is valid,
determining that subscription message is consented by a user, or
determining that one or more service thresholds associated with the subscription message are met.

7. The method of claim 1, wherein establishing the DCDN connection comprises one of:
establishing a protocol data unit (PDU) session to be used for the DCDN connection; or
using an existing PDU session for the DCDN connection.

8. The method of claim 1, wherein the namespace includes a set of data streams IDs associated with the WTRU.

9. The method of claim 1, wherein collecting the one or more data objects comprises:
initiating generation of the one or more data objects by a data source.

10. The method of claim 9, further comprising:
encoding the one or more data objects, wherein the message comprises at least one of: the one or more data objects or one or more encoded data objects.

11. A wireless transmit/receive unit (WTRU) comprising:
a transceiver; and
a processor, wherein the transceiver and the processor are configured to:
receive configuration information including one or more data collection and delivery network (DCDN) configuration information elements (IEs),
establish, based on the one or more DCDN configuration IEs, a DCDN connection with a DCDN peer,
transmit, based on the one or more DCDN configuration IEs, an announcement message including a namespace,
receive, from the DCDN peer, a subscription message including a data stream identifier (ID),
collect, based on the subscription message, one or more data objects corresponding to the data stream ID, and
transmit, to the DCDN peer, a message determined based on the one or more data objects, over the DCDN connection.

12. The WTRU of claim 11, wherein the transceiver and the processor are further configured to:
receive a trigger for establishing a connection with the DCDN peer,
wherein the DCDN connection is established based at least on the trigger.

13. The WTRU of claim 12, wherein the one or more DCDN configuration IEs include a DCDN trigger IE indicative of the trigger.

14. The WTRU of claim 11, wherein the transceiver and the processor are further configured to:
determine that the subscription message is acceptable; and
transmit, to the DCDN peer, a subscription response including the data stream ID indicating that the subscription message is accepted.

15. The WTRU of claim 14, wherein determining that the subscription message is acceptable comprises one or more of:
determining that the data stream ID indicated by the subscription message is valid,
determining that subscription message is consented by a user, or
determining that one or more service thresholds associated with the subscription message are met.

16. The WTRU of claim 11, wherein establishing the DCDN connection comprises one of:
establishing a protocol data unit (PDU) session used for the DCDN connection; or
using an existing PDU session for the DCDN connection.

17. A method performed by a radio access network (RAN) node, comprising:
receiving, from a core network (CN) node, configuration information including one or more data collection and delivery network (DCDN) configuration information elements (IEs);
establishing, based on the one or more DCDN configuration IEs, an internet protocol (IP) connection with a DCDN peer over an IP network;
receiving a subscription message from the DCDN peer including a data stream identifier (ID); and
transmitting, based on the subscription message, one or more data objects to corresponding to the data stream ID to the DCDN peer.

18. The method of claim 17, further comprising:
transmitting a message to a wireless transmit/receive unit (WTRU) for initiating data collection; and
receiving, from the WTRU, at least one message comprising the one or more data objects corresponding to the data stream ID.

19. The method of claim 17, further comprising:
generating the one or more data objects.

20. The method of claim 17, further comprising:
transmitting an announcement message including a namespace including a set of data streams IDs associated with the RAN node.
